(19) United States
(12) Patent Application Publication
(10) Pub. No.: US 2014/0184910 A1
(43) Pub. Date: Jul. 3, 2014

(54) Methods and Systems for Remote Controller Communication Network

(71) Applicant: Apex Technology Ventures, LLC, Houston, TX (US)

(72) Inventor: Benjamin D. Bailey, Roswell, GA (US)

(21) Appl. No.: 14/187,514

(22) Filed: Feb. 24, 2014

(51) Int. Cl. H04N 5/445

(52) U.S. Cl. CPC H04N 5/44582; H04N 5/44513
USPC 348/554

(57) ABSTRACT

Described herein are systems, devices, and methods for a remote controller communication network. The system may comprise one or more remote controllers communicatively coupled with a plurality of input and/or output devices, including but not limited to one or more display devices, peripheral devices, and/or switches. In some embodiments, a plurality of remote controllers may each be configured for initiating one of a plurality of activities that involve an overlapping subset of communicatively coupled devices. A determination as to whether a communicatively coupled device is available for a requested activity may be achieved through communication of status information between the remote controllers and/or other system devices.

### BACKGROUND OF THE DISCLOSURE

The average American household has approximately three televisions and this number is steadily increasing. Typically, a number of input or peripheral devices are connected to each television. For example, a television may be in communication with one or more of a cable box, a digital video recorder (“DVR”), a digital versatile disc (“DVD”) player, a blu-ray player, a media streamer (e.g., a Roku, Chromecast, or Apple TV), and an audio receiver. Of course, each of these devices, including the television, can be controlled with a dedicated remote control. As the number of devices in communication with a television increases, however, using and keeping track of all the remote controls becomes difficult and clumsy.

In response to the growing number of peripheral devices, universal remote controls capable of controlling multiple devices have become increasingly popular. A typical universal remote control may have an array of device-selection “buttons” each corresponding to a different device in an entertainment system. As used herein, the term “button” may describe a physical button capable of being depressed by a user, a virtual button appearing on a touchscreen, or any other physical/virtual switch, scroll wheel, or other input mechanism.

After the universal remote control has been paired with each device in the system and is thereby able to transmit commands to each device, a user can select the peripheral device he or she wishes to control by selecting the corresponding device input on the remote, and then transmit commands to the respective device using any combination of hard and soft buttons on the remote.

These remotes are still difficult to use in situations where the entertainment system comprises many devices, as a consumer must manually transmit commands to each device in order to place it in the correct state and/or setting for a desired media-consuming activity. For example, where a consumer desires to watch a DVD using a DVD player that transmits a video signal to a television and an audio signal to an audio receiver coupled to a plurality of speakers, the consumer may: (1) press a device-selection button on the remote corresponding to the DVD player, (2) press the remote's power button to turn the DVD player on, (3) press a device-selection button on the remote corresponding to the television, (4) press the remote's power button to turn the television on, (5) press an input button on the remote to set the television to the appropriate input, (6) press a device-selection button on the remote corresponding to the receiver, (7) press the remote's power button to turn the receiver on, and (8) press an input button on the remote to set the receiver to the appropriate input. Obviously, such a process is cumbersome and can be very confusing for consumers, particularly those unfamiliar with how the television and its peripherals were setup or installed.

Activity-based universal remote controls such as Logitech's Harmony product line have attempted to address these issues by automating the various steps a consumer would normally engage in to launch a particular media-consuming activity. In the above example, rather than manipulating the universal remote control to send each command to each respective device in the entertainment system, a consumer may simply press a button on the remote for initiating an activity such as “watch a DVD.” Based on information previously entered by the consumer during setup of the remote, the remote may then serially transmit commands corresponding to the aforementioned steps (1)-(8) to place all of the relevant devices in their desired states.

Unfortunately, even if a consumer has programmed such an activity-based remote to operate a television and a plurality of peripheral or input devices in communication with the television, if the consumer desires to install a new television elsewhere in his or her home and be able to enjoy all the same functions on the second television that he or she is accustomed to enjoying on the first television, the consumer is faced with having to purchase duplicative (or at least comparable) devices and another universal remote. Additionally, the consumer must program the new remote to work with the entertainment equipment. In an environment where the number of televisions in a household is ever-increasing, each additional television or monitor installed in the home represents a significant investment in terms of money and time.

Accordingly, current universal remote controller systems and methods could benefit from improved devices and techniques for communicating with entertainment system devices. Additionally, current universal remote controller systems and methods could benefit from improved devices and techniques for programming the controller systems to communicate with a household's electronic devices.

### SUMMARY OF THE DISCLOSURE

In accordance with certain embodiments of the present disclosure, a system and method for a remote controller communication network is disclosed. The system may comprise one or more display devices (e.g., televisions, monitors, etc.), one or more peripheral devices (e.g., input/source/content devices, A/V receivers, etc.), one or more switches or matrices, and a plurality of remote controllers. As used herein, the terms “switch” and “matrix” may be used interchangeably to describe a device for routing an input A/V signal to an output device. Some embodiments may further comprise a signal repeater for relaying signals to and from one or more components in the system.

In one aspect, rather than one or more peripherals being in communication with a dedicated display device, all of the peripheral devices may be in communication with all of the display devices in a household. In one embodiment, the peripheral devices may be coupled to a switch or matrix in order to facilitate communication to a plurality of display devices.

In another aspect, each display device, or media-consuming area of the household may be associated with a remote controller. As used herein, the term “media-consuming area” is meant to describe an area of the household at which a user may consume (e.g., view, listen, etc.) media. In one embodiment, each remote controller may be an activity-based universal remote controller capable of setting a plurality of devices to a desired state in order to achieve an activity in which a user desires to engage. In one example, where a user selects an activity by manipulation of a button, the remote controller responds by serially transmitting a series of commands to one or more devices in an entertainment system, each command causing the one or more devices to perform a function or assume a desired state.

In a further aspect, upon receiving an activity request from the user, but prior to transmitting the series of commands to the one or more devices, the remote controller may communicate with one or more other remote controllers that may be associated with other media-consuming areas of the household (e.g., another room). In particular, the remote controllers in the household may transmit, receive, or exchange information with one another regarding activities in which those controllers are, or will be, engaged. In one embodiment, the information may comprise information identifying one or more devices that may be in use or engaged in an ongoing activity. In one embodiment, a remote controller may then use this information to configure available devices for an activity requested by the user at the controller.

In another aspect, once the remote controller has initiated a user's desired activity, the controller may record or store information indicative of what peripheral devices are being utilized in that activity and/or their present state. In one embodiment, the remote controller may also transmit this information to one or more other remote controllers in the household so that those controllers may also record or store the information.

Additional objects and advantages of the present disclosure will be set forth in part in the description which follows, and in part will be obvious from the description, or may be learned by practice of the disclosure. The objects and advantages of the disclosure will be realized and attained by means of the elements and combinations particularly pointed out in the appended claims.

It is to be understood that both the foregoing general description and the following detailed description are illustrative and explanatory only and are not restrictive of the claims.

The accompanying drawings, which are incorporated in and constitute a part of this specification, illustrate several embodiments and together with the description, serve to explain the principles of the disclosure.

### BRIEF DESCRIPTION OF THE DRAWINGS

FIG. 1 depicts some aspects of an illustrative embodiment of a system as described herein.

FIG. 2 depicts an illustrative embodiment of a computing system as described herein.

FIG. 3 depicts some aspects of an illustrative method as described herein.

FIG. 4 depicts some aspects of an illustrative system as described herein.

FIG. 5 depicts some aspects of an illustrative method as described herein.

FIG. 6 depicts some aspects of an illustrative method as described herein.

FIG. 7 depicts some aspects of an illustrative method as described herein.

FIG. 8A depicts some aspects of an illustrative system as described herein.

FIG. 8B depicts some aspects of an illustrative system as described herein.

FIG. 8C depicts some aspects of an illustrative system as described herein.

FIG. 8D depicts some aspects of an illustrative system as described herein.

FIG. 9 depicts some aspects of an illustrative method as described herein.

FIG. 10 depicts some aspects of an illustrative system as described herein.

FIG. 11 depicts some aspects of an illustrative system as described herein.

### DESCRIPTION OF ILLUSTRATIVE EMBODIMENTS

Disclosed herein are various embodiments of a remote controller communication system or network. Generally, the system can be used to reduce redundancies in media devices within a household, manage media consumption in one or more media-consuming areas, and/or reduce the time spent configuring universal remote controls and/or media devices within a household. A typical media-consuming area of a household comprises an output device (e.g., a display device or stereo/receiver) and one or more input devices (e.g., media content providers) in communication with the output device(s). For example, a consumer may own three televisions, desire DVR functionality on all three televisions, and, as a result, purchase or lease three DVRs. The same holds true for other audio/video media devices such as cable boxes, DVD players, blu-ray players, media streamers, amplifiers, receivers, etc. In fact, it is not uncommon for a consumer with three televisions or other display devices to purchase/lease three cable boxes, three blu-ray players, and three media streaming devices, despite the fact that rarely are more than some subset of these devices ever in use at any one time within the consumer's household.

The systems disclosed herein solve these problems by introducing a remote controller communication network over which a plurality of remote controllers in a household may communicate with each other and efficiently share common resources (i.e., input and output devices). The remote controllers, among other things, may store information pertaining to the devices engaged in any ongoing media-consuming activity and share that information with other remote controllers within the communication network. In this manner, when one remote controller receives a request from a user to engage in an activity, the remote controller can determine what media devices within the household are currently in use and configure the available devices to achieve the requested activity without interfering with ongoing activities in other media-consuming areas of the household. In one embodiment, a plurality of media devices are all in communication with each remote controller and each corresponding media-consuming environment in the household through, for example, an audio/video switch or matrix device.

While the systems and methods described herein are primarily concerned with media-based activities utilizing a display device, one skilled in the art will appreciate that the systems and methods described below can be used in other contexts, including any media-consuming activity reliant upon audio or video equipment. Additionally, while the systems and methods described herein focus on media consumption within a residential environment, one skilled in the art will appreciate that the same concepts apply to commercial and/or industrial environments.

Reference will now be made in detail to certain illustrative embodiments, examples of which are illustrated in the accompanying drawings. Wherever possible, the same reference numbers will be used throughout the drawings to refer to the same or like items.

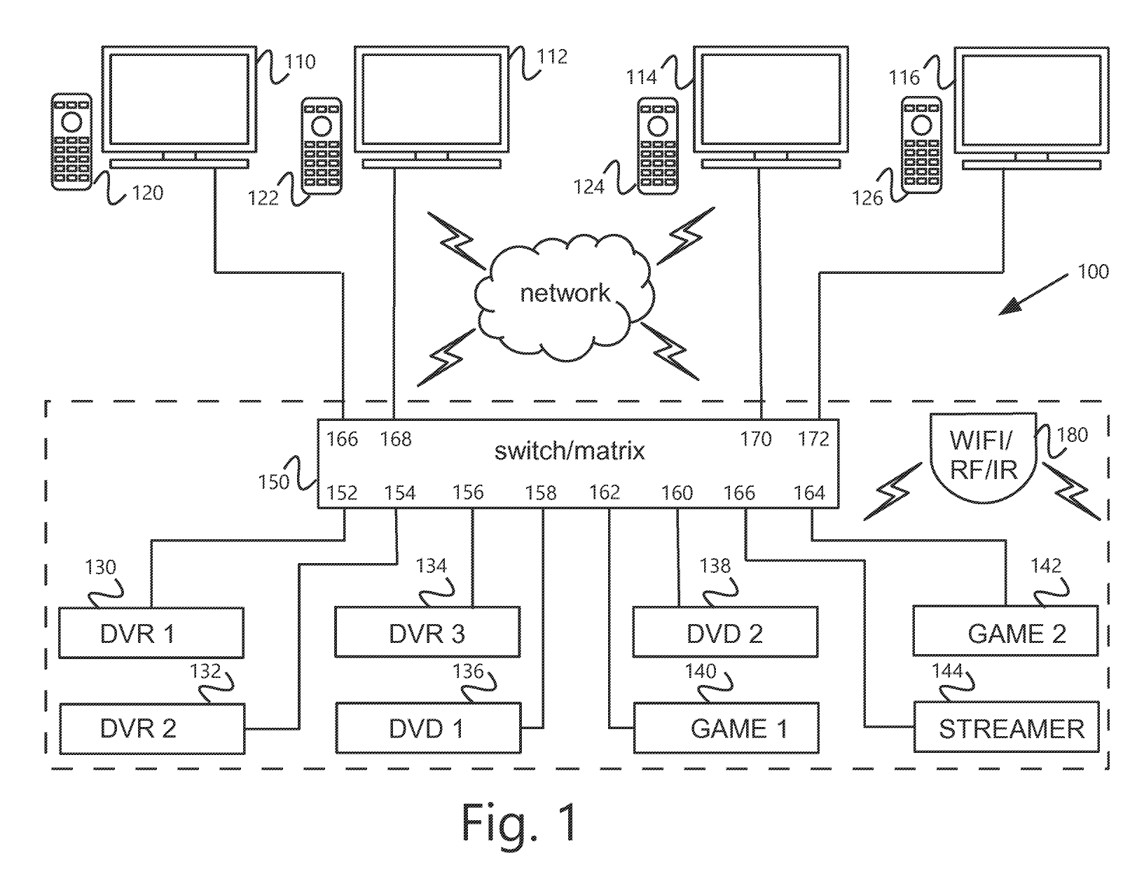

FIG. 1 illustrates one embodiment of a system 100. System 100 can comprise one or more display devices 110, 112, 114, 116, each associated with a respective remote controller 120, 122, 124, 126. In other embodiments, each remote controller may be associated with more than one of display devices 110, 112, 114, 116 or, vice versa, each display device may be associated with more than one of remote controllers 120, 122, 124, 126. As used herein, the term “display device” is meant to describe any device for displaying a visual image or video to a user, i.e., a television, a monitor, a projector, etc. In alternative embodiments, the display device may be a tablet, smart phone, laptop, desktop computer, or another device with a display for visual content. Though FIG. 1 depicts the remote controllers and display devices as distinct devices, in a further embodiment, one or more remote controllers 120, 122, 124, 126 may be built into or integrated with one or more respective display devices 110, 112, 114, 116.

In one aspect, display devices 110, 112, 114, 116 and remote controllers 120, 122, 124, 126 may be in communication with one another and configured to exchange commands and/or information. The display devices and remote controllers can be in one-way or two-way communication, and can be wire- or wirelessly-connected. In some embodiments, the remote controllers and the display devices can communicate via an IR or RF signal. In other embodiments, the remote controllers and the display devices can communicate via a Bluetooth or wi-fi communication channel. In further embodiments, the remote controllers and display devices can communicate over another wireless communication channel or a wired communication channel.

In one embodiment, and as depicted in FIG. 1, the remote controllers may be a handheld device configured to accept inputs from a user and transmit commands to one or more devices in communication with the controller, e.g., a display device. In other embodiments, remote controller may be another suitable controller- or processor-based device for receiving inputs from a user. For example, the remote controllers can be a smart phone or another portable computing device such as a cell phone, a tablet, a laptop, a head-mounted display device, or some other portable, electronic device. In further embodiments, the remote controllers can be any other portable or non-portable, controller- or processor-based device, such as a desktop computer.

In one aspect, one or more of the remote controllers may be an activity-based remote controller, as described above. In one embodiment, the remote controllers may comprise a combination of buttons, touchscreens, scroll wheels, switches, and other components configured to receive input from a user. The remote controllers may further comprise components necessary for transmitting commands/signals to other controller- or processor-based components in response to the user's input(s).

It should be noted that while FIG. 1 depicts system 100 comprising four display devices and four remote controllers, other embodiments may comprise more or fewer display devices and/or more or fewer remote controllers. The depiction of display devices 110, 112, 114, 116 and remote controllers 120, 122, 124, 126 in FIG. 1 embodiment should not be construed to exclude embodiments where one or more of the remote controllers is integrated into one or more of the display devices. Moreover, the depiction of display devices 110, 112, 114, 116 should not be construed to exclude embodiments comprising additional or alternative output devices, such as one or more A/V receivers, stereos, etc.

In another aspect, each display device 110, 112, 114, 116 may be in communication with one or more peripheral devices 130, 132, 134, 136, 138, 140, 142, 144. As used herein, the term “peripheral device” may include any controller- or processor-based component used in conjunction with a multi-media system. For example, peripheral devices may include, but should not be limited to, cable boxes, DVRs, DVD players, blu-ray players, gaming systems, media streamers, A/V receivers, amplifiers, smart phones, tablets, and laptop and desktop computers. FIG. 1 depicts a few examples of peripheral devices (i.e., DVRs, DVD players, gaming systems, and a media streamer), but should not be construed to exclude embodiments comprising fewer, more, or alternative peripheral devices.

In a further aspect, each of display devices 110, 112, 114, 116 may be in communication with all, or an overlapping subset, of the peripheral devices through an audio/video switch or matrix 150. A/V switches and matrices can be used to receive a plurality of video and audio input signals from respective source devices (e.g., peripheral devices) through one or more input ports. A/V switches or matrices may also selectively and concurrently route a plurality of video and audio input signals to one or more output devices (e.g., a display device or audio receiver) through one or more output ports. As discussed in more detail below, the input and output ports may be physical ports for facilitating a wired connection between the switch and a connected device, or they may be virtual for facilitating a wireless connection between the switch and a connected device. An m×n switch may have m input ports and n output ports. For example, a 4×2 switch may be configured to receive A/V signals from up to four source or input devices and selectively output the A/V signals from any of the four source devices to up to two destination or output devices. In one embodiment, as depicted in FIG. 1, an 8×4 switch may be used to facilitate communication between the eight peripheral devices 130, 132, 134, 136, 138, 140, 142, 144 and the four display devices 110, 112, 114, 116. In an alternative embodiment, switch 150 may be built in or integrated with any one or more of peripheral devices 130-144, remote controllers 120, 122, 124, 126, or display devices 110, 112, 114, 116. Moreover, though FIG. 1 depicts one switch 150, other embodiments may comprise a plurality of switches that may or may not be in communication with one another via any previously-described and suitable communication channel.

As shown, peripheral device 130 can transmit an A/V signal to switch 150 through an input port 152; peripheral device 132 can transmit an A/V signal to switch 150 through an input port 154; peripheral device 134 can transmit an A/V signal to switch 150 through an input port 156; peripheral device 136 can transmit an A/V signal to switch 150 through an input port 158; peripheral device 138 can transmit an A/V signal to switch 150 through an input port 160; peripheral device 140 can transmit an A/V signal to switch 150 through an input port 162; peripheral device 142 can transmit an A/V signal to switch 150 through an input port 164; and peripheral device 144 can transmit an A/V signal to switch 150 through an input port 166. Of course, the depicted configuration is only one embodiment and other embodiments may comprise a switch exhibiting fewer or more input ports and/or fewer, more, or alternative peripheral devices.

Also as depicted in FIG. 1, switch 150 may be in communication with: display device 110 through an output port 166; display device 112 through an output port 168; display device 114 through an output port 170; and display device 116 through an output port 172. Of course, the depicted configuration is only one embodiment and other embodiments may comprise a switch exhibiting fewer or more output ports and/or fewer, more, or alternative display devices and/or destination devices.

In another aspect, the peripheral devices may be in wire- or wireless-communication with switch 150 via any suitable communication channel for transmitting audio and/or video. In some embodiments, one or more of the peripheral devices may transmit audio and/or video to switch 150 via an HDMI communication channel, a component communication channel, a DVI communication channel, a VGA communication channel, an Ethernet communication channel, and/or an RGA communication channel. In other embodiments, one or more of the peripheral devices may transmit audio and/or video to switch 150 via a Bluetooth communication channel, a wi-fi communication channel, an IR communication channel, or an RF communication channel. In further embodiments, one or more of the peripheral devices may transmit audio and/or video to switch 150 via another wireless communication channel or a wired communication channel.

Similarly, the display devices 110, 112, 114, 116 may be in wire- or wireless-communication with switch 150 via any suitable communication channel for transmitting audio and/or video. As described above with respect to the peripheral devices, one or more of the display devices may send or receive audio and/or video from switch 150 via an HDMI communication channel, a component communication channel, a DVI communication channel, a VGA communication channel, an Ethernet communication channel, and/or an RGA communication channel. In other embodiments, one or more of the display devices may receive audio and/or video from switch 150 via a Bluetooth communication channel, a wi-fi communication channel, an IR communication channel, or an RF communication channel. In further embodiments, one or more of the display devices may receive audio and/or video from switch 150 via another wireless communication channel or a wired communication channel.

In this manner, where a user desires to transmit audio and/or video from any peripheral device to any display device, switch 150 may be configured to route an A/V signal from the desired content/input device to the desired output device. For example, where a user desires to display video from peripheral device 134 to display device 112, switch 150 can be configured to route the video signal received at input port 156 to output port 168. Alternatively, should the user desire to display video from peripheral device 134 to display 116, switch 150 can be configured to route the video signal received at input port 156 to output port 172.

In another aspect, switch 150, one or more of peripheral devices 130-144, and one or more of display devices 110-116 may receive commands/signals from one or more of remote controllers 120-126. As described above with respect to a communication channel between remote controllers 120-126 and display devices 110-116, remote controllers 120-126 may be in similar one-way or two-way communication with the peripheral devices and the switch, and can be wire- or wirelessly-connected. In some embodiments, the remote controllers can communicate with one or more peripheral devices and/or switches via an IR or RF signal. In other embodiments, the remote controllers and the peripheral devices and/or switches can communicate via a Bluetooth or wi-fi communication channel. In further embodiments, the remote controllers and peripheral devices and/or switches can communicate over another wireless communication channel or a wired communication channel.

In a further embodiment, where one or more of the peripheral devices and/or switches rely on a line of sight communication channel (e.g., an IR signal) between the device and a remote controller, and either no line of sight exists or a user does not wish to rely on a line of sight, system 100 may comprise a signal repeater 180. In one embodiment, one or more of remote controllers may communicate with repeater 180 via a communication channel that does not require a line of sight, such as, but not limited to, an RF signal, a Bluetooth signal, or a wi-fi signal. Repeater 180 may be positioned such that it enjoys a line of sight with one or more of the peripheral devices and/or switches. Alternatively, repeater 180 may have wired output emitters that extend to a position enjoying a line of sight with one or more of the peripheral devices and/or switches. For example, repeater 180 may receive a signal/command from a remote controller via an RF or wi-fi signal, convert that signal into an IR signal, and transmit that IR signal to a peripheral device/switch (optionally using a wired emitter extending from the repeater). In another embodiment, repeater 180 may be integrated with one or more of switch 150 and peripheral devices 130-144.

Thus, when a user requests initiation of a media-related activity at one of the remote controllers, the remote controller may issue one or more commands to one or more of display devices 110-116, peripheral devices 130-144, switch 150, and repeater 180 in order to accomplish the desired activity and properly configure each associated device.

In another aspect, however, prior to configuring the devices associated with the desired activity, the remote controller receiving the user's input may confirm the present state of the devices associated with the desired activity. In one embodiment, each remote controller can maintain a record of ongoing media activities taking place within the household and which peripheral devices are currently in use and, therefore, unavailable. Additionally or alternatively, each remote controller may communicate with one or more other remote controllers in the household to determine what media-consuming activities are taking place within the household and which peripheral devices are currently in use. Communication between two or more remote controllers may be performed using any of the aforementioned wired- or wireless-communication channels.

In one embodiment, where a user requests an activity at a remote controller associated with a display device, and that activity requires a peripheral of a first type (e.g., cable box) and another peripheral device of a second type (e.g., an A/V receiver), the remote controller can determine whether there is an available (e.g., not currently in use) peripheral device of the first type and an available peripheral device of the second type. If there are peripheral devices of both types available, the remote controller may initiate the activity by transmitting commands/signals to the available peripheral devices and the display device associated with the remote controller. If there are no peripheral devices available of one or more of the first and second type, then the remote controller may inform the user that the requested activity is unavailable. For example, where system 100 comprises three cable boxes in communication with switch 150, up to three different, concurrent users or media-consuming areas of the household may engage in activities requiring a cable box. However, where a fourth concurrent instance of such an activity requiring a cable box is requested in a media-consuming area of the household, the requesting user may receive an unavailability message.

As discussed above, each remote controller may determine the status (i.e., availability and current configuration) of each peripheral device in system 100 based, at least in part, on records stored at the remote controller or through communication with one or more other remote controllers in the household, each of which transmits status information pertaining to peripheral devices engaged in an activity initiated at that respective remote controller.

In another embodiment, switch 150 may maintain a record of which peripheral devices are in use. Prior to any remote controller initiating an activity at a media-consuming area of the household, the remote controller may communicate with the switch in order to determine whether the necessary peripheral devices for initiating the activity are available. Of course, alternative embodiments of system 100 are possible in which any combination of one or more of the remote controllers and switch maintain a record of the current status of each peripheral device within the system.

In another aspect, once a remote controller has initiated an activity in a media-consuming area of the household, the remote controller may store information indicative of the status or unavailability of one or more peripheral devices being used in the activity. In one embodiment, in addition to storing the information, the remote controller may transmit the information indicative of the status of the currently-engaged devices to one or more other remote controllers in the system. In this manner, all of the remote controllers in system 100 may maintain an up-to-date record of the status of all peripheral devices.

In addition, or as alternative, to storing information regarding the use of one or more peripheral devices, the one or more remote controllers may also store information regarding the current configuration of switch 150. In this manner, one or more remote controllers in system 100 may track which inputs and outputs of the switch are being engaged for use in an ongoing activity and which are available for any request to initiate a new activity. For example, where a particular peripheral device may be in communication with a corresponding input port of the switch, a remote controller may determine that the particular peripheral device is unavailable where the corresponding input port of the switch is already in use.

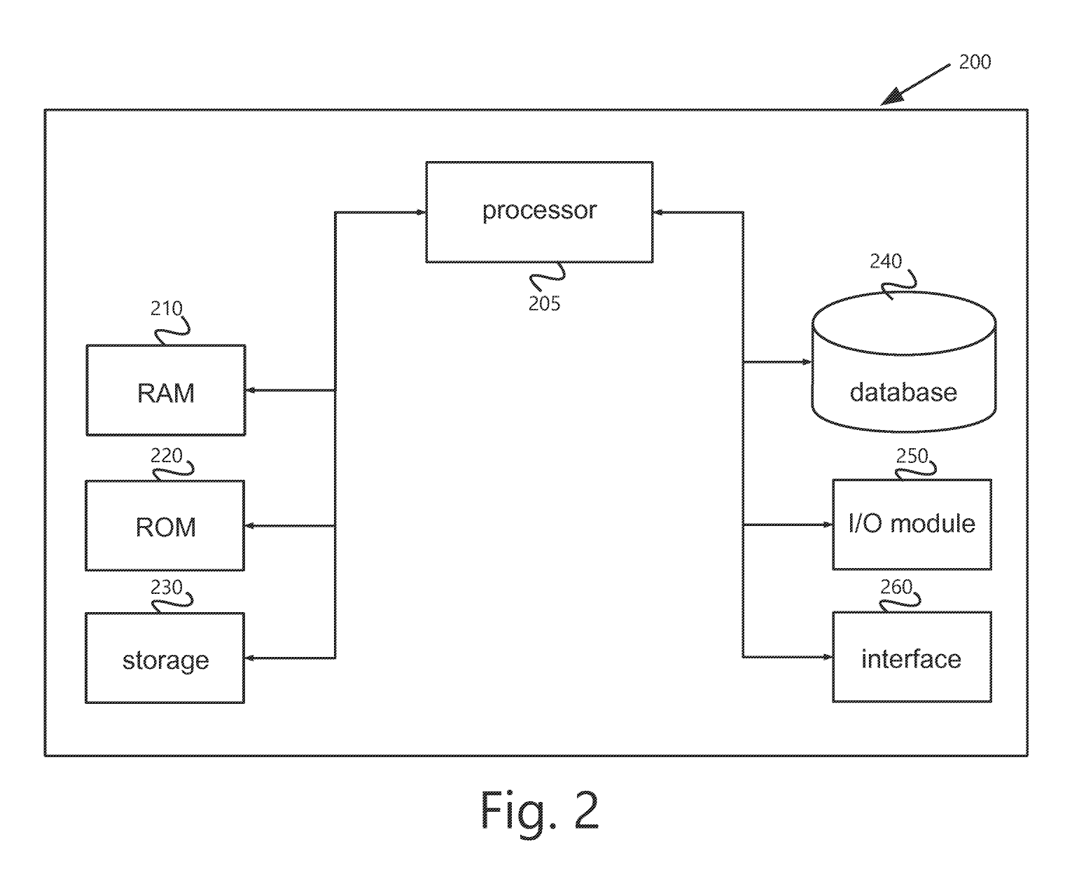

FIG. 2 depicts a processor-based computing system 200 representative of a computing system found in any one or more of display devices 110-116, remote controllers 120-126, peripheral devices 130-144, switch 150, and repeater 180.

In particular, system 200 may include one or more hardware and/or software components configured to execute software programs, such as software or circuitry for storing, processing, and analyzing data. For example, system 200 may include one or more hardware components such as, for example, processor 205, a random access memory (RAM) module 210, a read-only memory (ROM) module 220, a storage system 230, a database 240, one or more input/output (I/O) modules 250, and an interface module 260. Alternatively and/or additionally, system 200 may include one or more software components such as, for example, a computer-readable medium including computer-executable instructions for performing methods consistent with certain disclosed embodiments. It is contemplated that one or more of the hardware components listed above may be implemented using software. For example, storage 230 may include a software partition associated with one or more other hardware components of system 200. System 200 may include additional, fewer, and/or different components than those listed above. It is understood that the components listed above are illustrative only and not intended to be limiting.

Processor 205 may include one or more processors, each configured to execute instructions and process data to perform one or more functions associated with system 200. As illustrated in FIG. 2, processor 205 may be communicatively coupled to RAM 210, ROM 220, storage 230, database 240, I/O module 250, and interface module 260. Processor 205 may be configured to execute sequences of computer program instructions to perform various processes, which will be described in detail below. The computer program instructions may be loaded into RAM for execution by processor 205.

RAM 210 and ROM 220 may each include one or more devices for storing information associated with an operation of system 200 and/or processor 205. For example, ROM 220 may include a memory device configured to access and store information associated with system 200, including information for identifying, initializing, and monitoring the operation of one or more components and subsystems of system 200. RAM 210 may include a memory device for storing data associated with one or more operations of processor 205. For example, ROM 220 may load instructions into RAM 210 for execution by processor 205.

Storage 230 may include any type of storage device configured to store information that processor 205 may need to perform processes consistent with the disclosed embodiments.

Database 240 may include one or more software and/or hardware components that cooperate to store, organize, sort, filter, and/or arrange data used by system 200 and/or processor 205. For example, database 240 may include user-specific account information, predetermined menu/display options, and other user preferences. Alternatively, database 240 may store additional and/or different information.

I/O module 250 may include one or more components configured to transmit information between the various components of system 100. For example, I/O module 250 may facilitate transmission of data between remote controller 120 and one or more of display device 110, peripheral device 130, and switch 150. I/O module 250 may further allow a user to input parameters associated with system 200 via a touchpad, keypad, touchscreen, or another input component of one or more of display devices 110-116, remote controllers 120-126, peripheral devices 130-144, switch 150, and repeater 180. I/O module 250 may also facilitate transmission of visual indicators (e.g., LED indicators) or display data including a graphical user interface (GUI) for outputting information onto a viewing surface or graphical display. I/O module 250 may also include peripheral devices such as, for example, ports to allow a user to input data stored on a portable media device, a microphone, or any other suitable type of interface device. I/O module 250 may also include ports to allow a user to output data stored within any component of system 100 to, for example, an external component.

Interface 260 may include one or more components configured to transmit and receive data via a communication network, such as the Internet, a local area network, a workstation peer-to-peer network, a direct link network, a wireless network, or any other suitable communication platform. For example, interface 260 may include one or more modulators, demodulators, multiplexers, demultiplexers, network communication devices, wireless devices, antennas, modems, and any other type of device configured to enable data communication via a communication network.

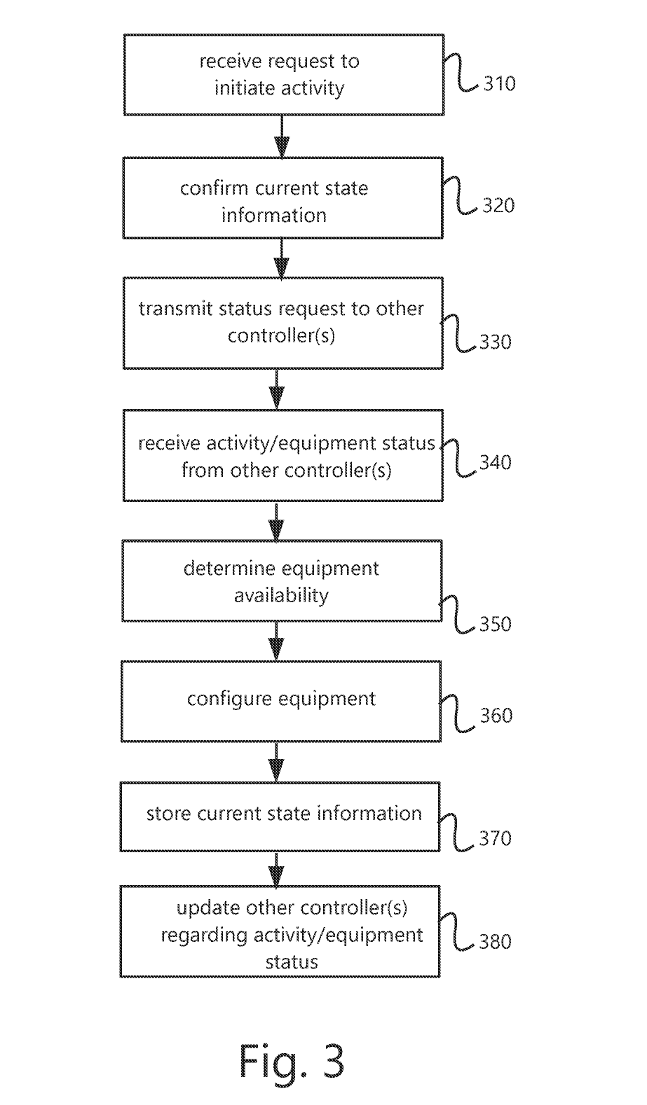

FIG. 3 depicts aspects of a method for initiating a requested activity at a media-consuming area of a household. First, at step 310, a remote controller 110 may receive a request from a user to initiate a desired activity at a media-consuming area. The request may be received through any one or more components of the remote controller configured to accept input from the user, examples of which are provided above.

At step 320, in response to receiving the request to initiate a desired activity, remote controller may access records maintained in a database to determine whether another activity is currently ongoing at the media-consuming area and, if so, what peripheral devices are currently in use. Where the desired activity requires the same peripheral devices of an ongoing activity, no further analysis regarding other devices of system 100 may be necessary, and remote controller may transmit signals/commands to the already engaged peripherals to achieve the desired activity. Where the desired activity requires alternative peripheral devices from those engaged in the ongoing activity, the unneeded peripherals may be turned off and information indicating those peripherals new availability may be stored in the database. Further, the remote controller may determine whether peripheral devices necessary to engage in the requested activity are available.

In one embodiment, remote controller 110 may analyze data stored in the database to determine the current status of any necessary peripheral devices in system 100. As discussed above, the database may be maintained within remote controller 110, switch 150, any peripheral devices, and/or another database. In one embodiment, after a remote controller in the household engages one or more peripheral devices in an activity, the respective remote controller may transmit a status update to one or more of the other remote controllers in the household. The status update may comprise information identifying the peripheral devices currently engaged in the activity. A similar status update may be transmitted each time an activity ends, the status update comprising information indicating the new availability of the previously-engaged peripheral devices. In this manner, each remote controller that receives the update(s), and similar updates from other remote controllers in the household, may maintain an accurate record of all peripheral devices engaged in ongoing activities. In another embodiment, and as described briefly above, switch 150 may maintain a record of all currently engaged and/or available peripheral devices. Switch 150 may maintain its record through the receipt of status updates, as described above with respect to an inter-remote controller embodiment, or it may create a record based on its own current state and which input and output ports are currently in use.

At step 330, if a remote controller does not have an up-to-date record indicative of the current availability of one or more peripheral devices (through, for example, the aforementioned status updates) or if the remote controller only stores information indicative of peripheral devices associated with ongoing activities initiated at that remote controller, the remote controller may transmit a status request to one or more other remote controllers in the household requesting information pertaining to any ongoing activities initiated by the other remote controllers in other media-consuming areas of the household, this information containing data indicative of which peripheral devices are currently engaged in those ongoing activities and, therefore, are unavailable for use in other media-consuming areas.

The other remote controllers, upon receiving such a status request, may retrieve data from a database indicative of which peripherals are currently engaged in an activity at a respective media-consuming area. For example, a second remote having last received a user request to initiate a media-consuming activity may, in response to receiving a status request from a first remote, retrieve data from a database indicating that a first television, a first blu-ray player, and a first A/V receiver are presently engaged in an activity associated with the second remote controller. In one embodiment, the second remote controller may then transmit a status update to the first remote controller, the status update comprising the data indicating which peripheral devices are currently engaged.

At step 340, the requesting remote controller may receive the status update. In one embodiment, the requesting remote controller may receive a plurality of status updates, each from a different remote controller in the household. In one aspect, and in order to avoid overlapping transmissions and/or one or more status updates not being received, the requesting remote controller may transmit status requests to each of the other remote controllers in the household serially or one at a time. Further, after transmitting one status request, the requesting remote controller may not transmit another status request until a status update is received from the recipient of the initial request. Thus, the risk that two or more status updates would be transmitted concurrently, and that one or more status updates may not be received or comprehended, is greatly reduced. In another embodiment, the status updates from each responding remote controller may be received at switch 150, compiled, and then transmitted to the requesting remote controller. Of course, other suitable embodiments can be used, and the above examples are meant only to be illustrative of the possibilities.

At step 350, the requesting or originating remote controller, having access to a complete record indicative of the status of all peripheral devices in system 100, may assess whether the devices necessary to engage in the activity requested by the user at step 310 are available. In one embodiment, a user may own (or system 100 may comprise) a plurality of peripheral devices of a like type (e.g., a plurality of DVD players or a plurality of cable boxes). In such embodiments, a priority may be assigned to each device of the like type, such that the status of each such device may be confirmed in a predetermined order until either an available device is identified or a determination may be made that all the devices of that type are currently engaged in an activity.

For example, where a user has requested an activity requiring a DVD player, the remote controller may cross-reference stored data to determine if a DVD player is available. Where a user owns (or system 100 comprises) a plurality of DVD players, the remote controller may first confirm the status of the highest priority DVD player. Where the highest priority device is available, that device may be used in the requested activity. Where the highest priority device is unavailable (i.e., engaged in an ongoing activity), the remote controller may determine the status of a DVD player having a second highest priority, and so on. This iterative process may repeat itself until either an available DVD player is identified or it is determined that all DVD players within system 100 are currently engaged in other activities.

The priority assigned to each device of a like type may be assigned according to a predetermined algorithm or it may be input by a user during setup. For example, a user may select or configure the priority order of devices of a like type using any suitable criteria, including but not limited to, which of the devices most closely satisfy their desired functionality, which of the devices has the most advanced features, or which of the devices have the most appealing user interface. Alternatively, the priority of devices of a like type may be algorithmically automated, again based on any suitable criteria, including, for example, the type of connection each device of the like type has to switch 150. For instance, a media streamer coupled to switch 150 via an HDMI cable may be afforded priority over a media streamer coupled to switch 150 via component or RGA cables. Of course, other possibilities also exist, including a processor during which the priority order of all like devices is configured in an automated fashion, but a user may then manually override or alter the priority order.

Where a requested activity may utilize more than one peripheral device (each of a different type), a similar process may be implemented for each device type until a device of each type is identified as available for use in the requested activity. Of course, if no available device is found for any necessary device type, a message may be transmitted to the user indicating that the requested activity is not possible at this time based on other ongoing activities within the household.

In embodiments where switch 150 maintains a database containing information indicative of each peripheral device's status, the remote controller may transmit a command/signal to switch 150 requesting use of the highest priority device of a device type. In response, switch 150 may transmit information to the remote controller indicating that either the highest priority device is available or unavailable. Where the highest priority device is unavailable, the remote controller may transmit a command/device to switch 150 requesting use of the next highest priority device of the device type, and so on.

In still a further embodiment, the remote controller may transmit a command/signal to switch 150 requesting a peripheral device of a particular type without identifying a specific device. In response to receiving such a command/signal, switch 150 may perform a process substantially similar to the one described above with respect to the remote controller in which the switch performs an iterative process to determine the highest prioritized device of the particular type that is available. For example, where switch 150 receives a request from a remote controller to engage a cable box in an activity, switch 150 may first determine whether the cable box having a highest priority is already engaged in an activity. If it is not, switch 150 may transmit a message to the remote controller identifying that cable box is available. If, on the other hand, the highest priority cable box is engaged in an ongoing activity, switch 150 may determine the status of a next highest priority cable box, and so on.

Regardless of the method employed to identify the availability of any necessary peripheral devices, once an available peripheral device of each necessary type is identified, the remote controller may then transmit one or more commands/signals to the identified peripheral device(s) in order to configure them for the requested activity at step 360. In one embodiment, and depending upon the communication capabilities of the remote controller and the identified peripheral device(s), the remote controller may transmit commands/signals directly to the identified peripheral device(s) via one of the aforementioned communication channels (e.g., IR, RF, or wi-fi signals). In another embodiment, the remote controller may transmit one or more commands/signals to repeater 180 via one of the aforementioned communication channels, and repeater 180 may then relay the commands/signals to the identified peripheral device(s). For example, where an identified peripheral device is configured to receive commands/signals only via an IR signal, and no line of sight exists between the identified peripheral device and the remote controller, the repeater may be positioned such that it or one of its emitters establishes a line of sight with the identified peripheral device. The remote controller may then transmit commands/signals to repeater 180 via any of the aforementioned communication channels and the repeater may then convert the command/signal into an IR signal which is transmitted to the identified peripheral device.

In addition to configuring each identified peripheral device, remote controller may also transmit one or more commands/signals to switch 150 in order to properly configure the switch to route signals output from the identified peripheral device(s) to the appropriate media-consuming area of the household (e.g., a display device). In other words, switch 150 may be configured to route an input signal received at one of its input ports to an output device connected to one of its output ports. The communication between the remote controller and the switch may be accomplished as described above with respect to the remote controller(s) and the peripheral device(s). Further, repeater 180 may or may not be used to relay commands/signals between the remote controller(s) and the switch.

The configuration of switch 150, including data indicating which peripheral devices are connected to which input ports of the switch, and which display/output devices are connected to which output ports of the switch may be stored in a record substantially similar to the record(s) pertaining to the availability of each peripheral device in system 100. In one embodiment, a user may supply information during system setup indicative of which devices are coupled to which input(s)/output(s) of the switch. In other embodiments, one or more signals may be exchanged between the switch and the connected devices such that the switch can automatedly identify the type of device connected to each of the switch ports.

In an alternative embodiment, switch 150 may self-configure in response to the configuration of one or more input and/or output devices without direct communication with a remote controller. For example, where switch 150 may detect that a peripheral device connected to input 152 and display device 114 have both been turned on within a predetermined amount of time, switch 150 may respond by routing the signals received at input 152 to the output port connected to display device 114.

At step 370, after all the selected devices for an activity have been configured, a remote controller may store information pertaining to the current state of all newly engaged devices in a database. As described above, the database may be integrated with the remote controller or it may be maintained outside the remote controller. In this manner, the remote controller may supplement a record containing the status of all peripherals in system 100 with the status of any newly engaged peripherals in order to keep the record up-to-date.

Additionally, or in alternative embodiments, the remote controller may transmit updated information indicative of the status of any newly engaged devices to one or more other remote controllers in system 100 and/or switch 150 at step 380. Thus, a comprehensive and up-to-date record containing the status of one or more peripherals in system 100 may be maintained by a plurality of devices and information within the record may be relied upon by any record-holding devices to make future determinations as to the availability of one or more peripheral devices.

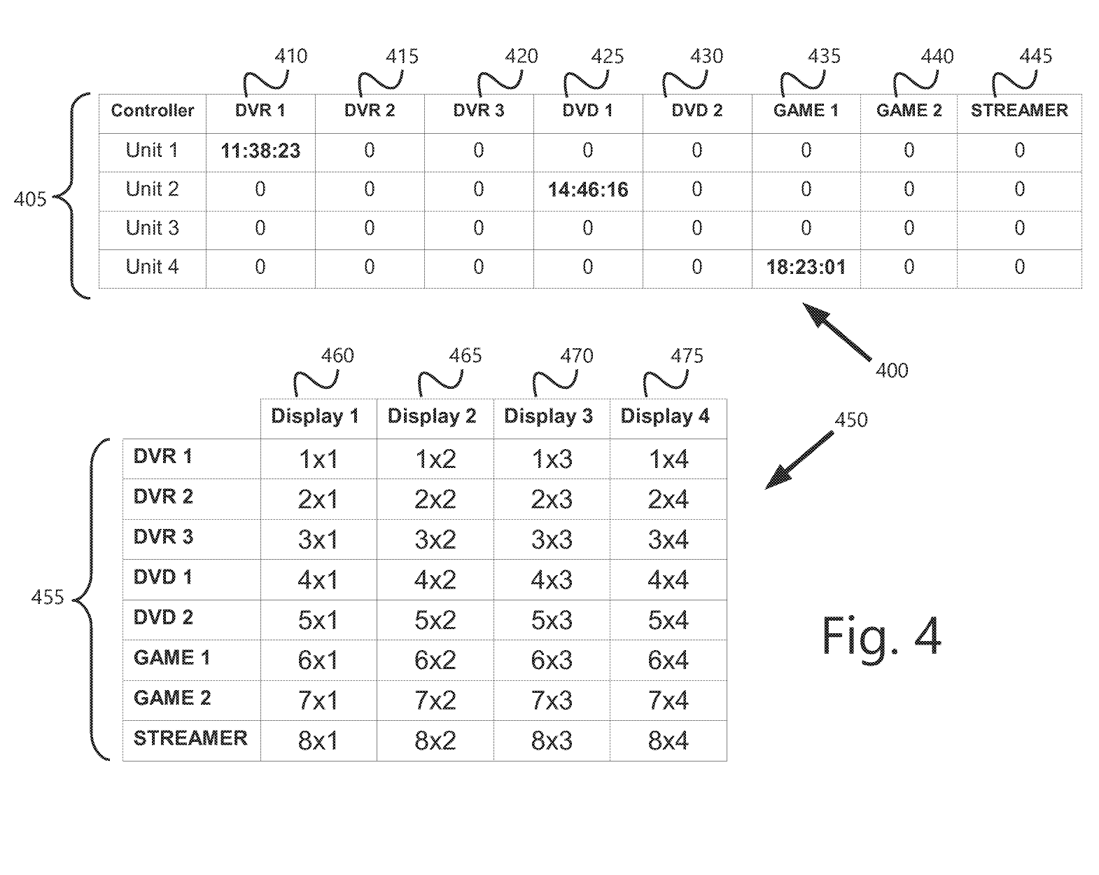

FIG. 4 depicts an example of a record 400 comprising peripheral device status information stored by one or more remote controllers, matrices, and/or external databases. In one aspect, record 400 can comprise a plurality of remote controller identifiers 405 and a plurality of peripheral device identifiers 410, 415, 420, 425, 430, 435, 440, 445. Moreover, record 400 may indicate a priority order where more than one peripheral of a particular type is present in system 100. For example, as depicted in FIG. 4, DVR 1 may have priority over DVR 2 and DVR 3, and DVR 2 may have priority over DVR 3. Of course, the number of remote controllers and peripheral devices depicted in record 400 is only illustrative, as is the particular device priority order among devices of a like type. Other embodiments of record 400 may contain identifiers for more, less, or alternative remote controllers and/or devices, and any suitable system or method of recording device priority within a device type may be utilized. The examples provided herein should not be construed as exhaustive of the possibilities. For example, an alternative embodiment of record 400 may comprise additional or alternative data entries corresponding to one or more output devices, such as display devices or A/V receivers, etc.

In one embodiment, a plurality of ones and zeros are used within record 400 to indicate whether a peripheral device is available or currently engaged in an activity. For example, a one may indicate that a peripheral device is currently engaged in an activity and a zero may indicate that a device is available. In another embodiment, and as depicted in FIG. 4, information indicating that a peripheral device is engaged in an ongoing activity may be associated with a time stamp indicative of when the peripheral device became engaged in the activity. Further, where a peripheral device is currently engaged in an activity, record 400 may identify which remote controller in system 100 engaged the peripheral device in its current activity. Thus, in the example depicted in FIG. 4, remote controller unit 1 engaged peripheral device 410 (in this example, the DVR with the highest priority) at 11:38:23 and, therefore, peripheral device 410 is unavailable to other media-consuming areas of the household and/or other remote controller units in the household until the activity is terminated and/or record 400 is updated to reflect that the activity has been terminated. Similarly, remote controller unit 2 engaged peripheral device 425 (the DVD player with the highest priority) in an activity at 14:46:16, and remote controller 4 engaged peripheral device 435 (the gaming system with the highest priority) in an activity at 18:23:01. In the example shown, record 400 may also convey that remote controller unit 3 has not engaged any peripheral devices in an activity, and peripheral devices 415, 420, 430, 440, and 445 are available.

Where record 400 represents up-to-date status information and a user requests initiation of an activity at remote controller unit 3, information contained in record 400 may be used to identify one or more available peripheral devices. For example, should a user request initiation of an activity requiring a DVR at remote controller unit 3, remote controller unit 3 and/or switch 150 may determine, based at least in part on the information contained in record 400, that DVR 1 is engaged in an ongoing activity, but DVR 2 is available. In such an instance, remote controller 3 may then transmit commands/signals to one or more of DVR 2, switch 150, and an associated output device in order to initiate the requested activity. Remote controller 3 and/or switch 150 may then update record 400 to indicate that DVR 2 (peripheral device 415) is engaged in an activity initiated by remote controller unit 3.

FIG. 4 further depicts an example of record 450 comprising information that may be used to properly configure switch 150 for a requested activity. In one embodiment, record 450 may comprise a plurality of input device identifiers 455 and a plurality of output device identifiers 460, 465, 470, 475. In the particular example shown in FIG. 4, input device identifiers 455 of record 450 may correspond to peripheral device identifiers 410-445 of record 400 and output device identifiers 460-475 may correspond to respective display devices. Of course, the number of input and output devices depicted in record 450 is only illustrative. Other embodiments of record 450 may contain identifiers for more, less, or alternative input and/or output devices, and may depend, at least in part, on the capabilities of switch 150 (e.g., the number of input and output ports of switch 150 and/or the number of concurrent activities switch 150 may support). The examples provided herein should not be construed as exhaustive of the possibilities.

Upon selection of an input device and an output device associated with a requested activity, record 450 may be used to configure switch 150 for properly routing an input signal received at an input port to the output device connected to an output port. For example, where a user requests initiation of an activity at a media-consuming area of the household that requires output device 470 (e.g., an output device associated with that media-consuming area) and a DVD player, it may first be determined that DVD 2 is the highest priority DVD player available (i.e., not engaged in an ongoing activity). Such a determination may be made according to any of the aforementioned systems and/or processes. Record 450 may then be used to configure switch 150 such that an input signal received at input port 5 of switch 150 (the input port to which DVD 2 is connected) should be routed to the output device 470 connected to output port 3. As described above, records 400 and 450 may be maintained and/or updated at one or more of remote controllers and switches within system 100, depending upon the configuration of the system. Furthermore, one or more of the remote controllers and switches may exchange information such that an updated record containing status and configuration information pertaining to the devices of system 100 may be maintained in multiple locations. Maintaining the information in multiple locations may not only expedite the initiation of a requested activity by reducing the number of inter-device communications that must take place, but record redundancy also serves as a safe-guard against one or more of the records being lost, corrupted, or otherwise damaged.

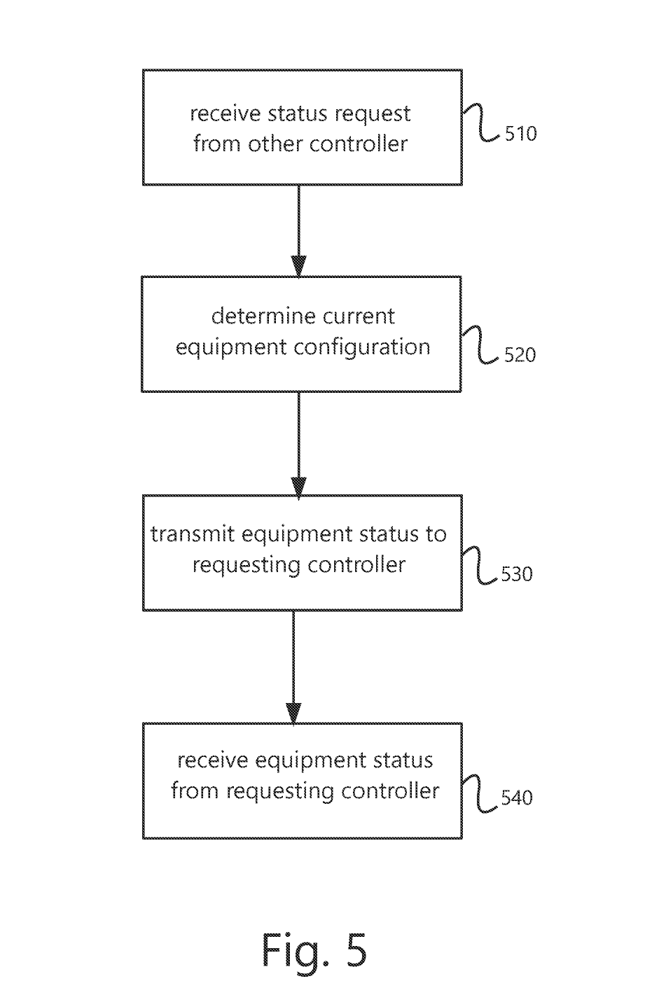

FIG. 5 depicts aspects of a method for receiving and responding to a status request transmitted by a device in system 100. In one embodiment, a remote controller may receive a status request from another remote controller. In other embodiments, a switch may receive a status request from a remote controller or, vice versa, a remote controller may receive a status request from a switch. Whether the device is a remote controller or a switch, at step 510, the receiving device may receive a status request from one or more other devices in system 100.

At step 520, in response to receiving the status request, the receiving device may determine what devices are engaged in an ongoing activity initiated at the receiving device. In one embodiment, the receiving device may analyze data in a database substantially similar to those described above, the database containing information indicative of the status of the devices engaged in an ongoing activity initiated at the receiving device. In another embodiment, the database may contain additional information indicative of the status of each peripheral device in system 100. In a further embodiment, the status request may only request information pertaining to devices of a device type associated with the activity requested at the requesting device. In other words, where a user requests initiation of an activity at the requesting device that may require a DVD player, the status request received by the receiving device may only request information pertaining to one or more DVD players in system 100 or, alternatively, the receiving device may only request information pertaining to any DVD players engaged in an ongoing activity initiated at the receiving device.

At step 530, the receiving device may transmit any known status information pertaining to one or more devices. As discussed above, in some embodiments, the status information may be limited to information pertaining to those devices engaged in an ongoing activity initiated at the receiving device. In other embodiments, the status information may comprise information pertaining to one or more other devices in system 100 that has been previously communicated or otherwise made accessible to the receiving device. In such an embodiment where a receiving device may respond to the status request by transmitting information pertaining to devices not engaged in an ongoing activity initiated at the receiving device, the status information for each peripheral device for which information may be transmitted may further comprise a time stamp associated with the present status of each device, the time stamp indicating the time at which the status of the respective device was known to be engaged in an activity. In this manner, where the requesting device receives conflicting status information from two or more receiving devices (e.g., one receiving device indicates that a first peripheral device is available and a second receiving device indicates that the first peripheral is engaged in an ongoing activity), the respective time stamps accompanying the status information for a particular device may be compared and the information associated with the oldest time stamp may be ignored in favor of the information associated with the more recent time stamp.

After transmitting the status information to the requesting device, the requesting device may select one or more available peripheral devices for an activity requested by a user at the requesting device, as described above. The requesting device may further transmit commands/signals to the one or more available devices in order to initiate the user-requested activity, as described above. At step 540, after the user-requested activity is initiated at the requesting device, the requesting device may transmit, and the receiving device may receive, a status update indicating the status of the newly engaged devices. In this manner, the receiving device may update its records to reflect the current status of any now-engaged devices.

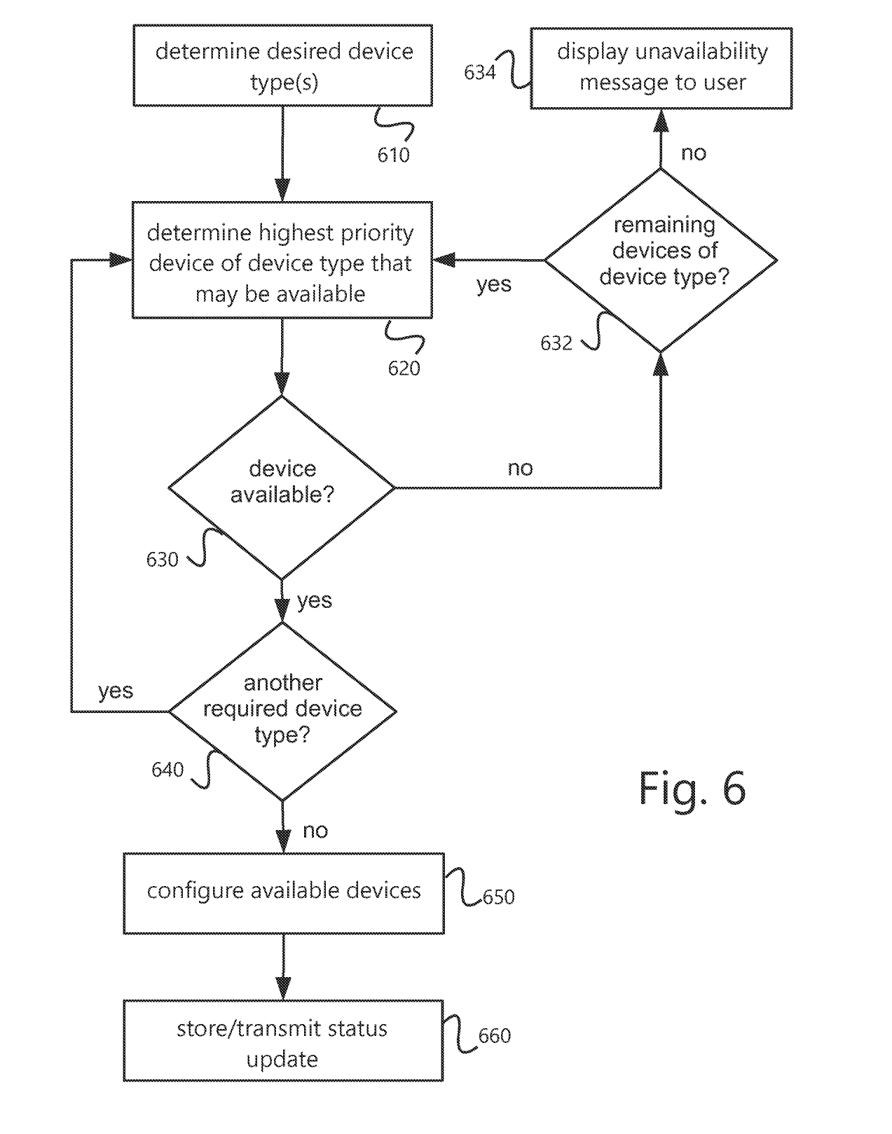

FIG. 6 depicts aspects of a method for configuring one or more input and output devices by a remote controller in system 100. As depicted in FIG. 6, the remote controller may already be in possession or have access to status information pertaining to one or more devices in system 100. The status information may have been acquired or accessed according to any of the aforementioned systems or processes.

At step 610, the remote controller may receive input from a user requesting initiation of an activity. In response to the received input, the remote controller may determine one or more input and output device types required to initiate the activity. For example, where a user requests initiation of a television watching activity, remote controller may determine that three device types are necessary to initiate the activity: a display device, an A/V receiver, and a cable box. In one embodiment, the display device may be a display device pre-associated with the remote controller. In such an embodiment, the associated display device may be considered available, as any ongoing activity involving the associated display device may be presumed to have been initiated at the remote controller, and therefore, is being overwritten or terminated by the user in favor of the newly requested activity.

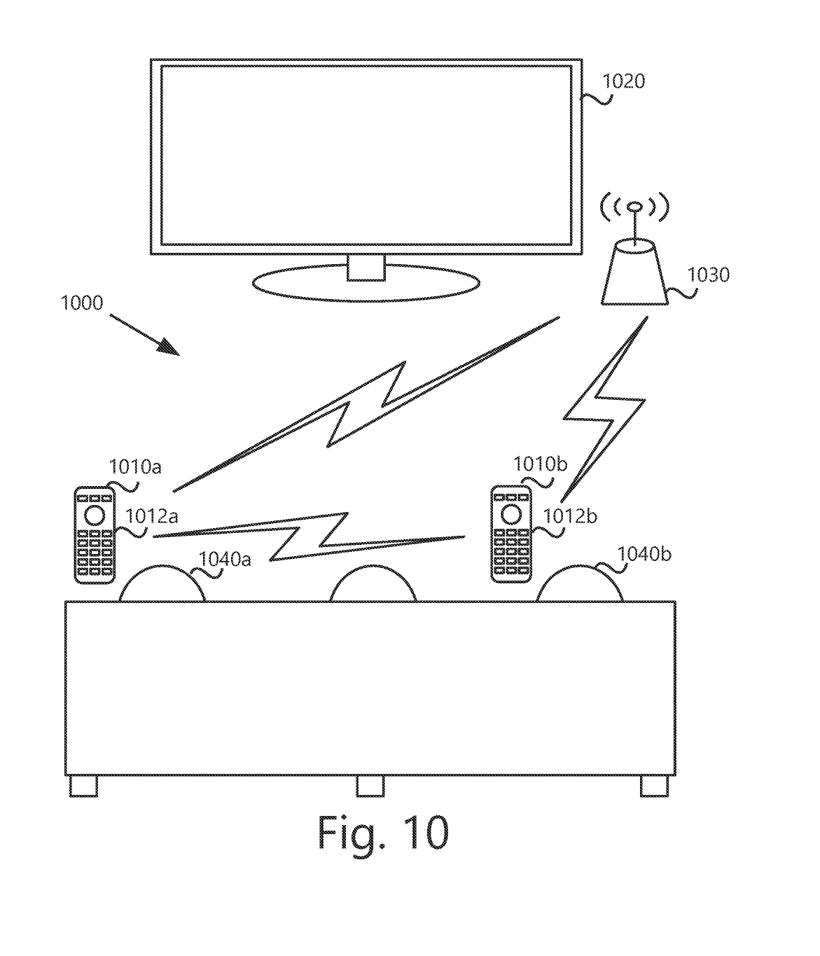

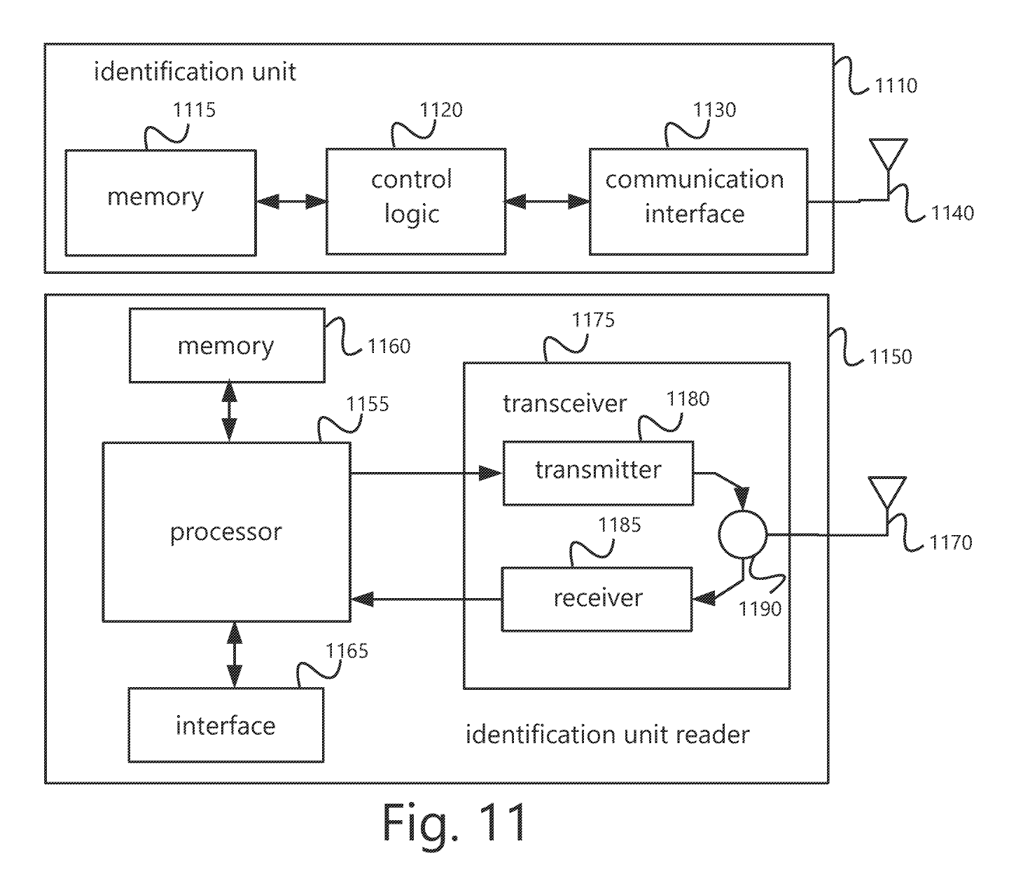

In other embodiments described below, where a display device is not necessary pre-associated with or dedicated to a particular remote controller, the availability of the display device may be determined in a similar fashion as that described herein with respect to the availability of a peripheral device. Alternatively, a display device may be determined according to systems and methods described below with respect to FIGS. 10 and 11.

Once a first desired device type is identified, at step 620, the remote controller may identify the highest priority device in system 100 of that device type. For example, where the first desired device type is a cable box, the remote controller may identify a cable box in system 100 with the highest priority ranking. Identification of the device having the highest priority ranking within a device type subset may be accomplished using any of the aforementioned systems or processes. In one embodiment, the remote controller may access a record similar to record 400 or 450 depicted in FIG. 4 to determine the highest ranking device within a device type. As described above, record 400 or 450 may be maintained at the remote controller, at another remote controller in system 100, at a switch within system 100, or at an independent database within system 100. In other embodiments, the remote controller may access another similarly stored record comprising device priority information, such as a record created based, at least in part, on feedback supplied by a user at the time system 100 and/or the remote controller were setup or configured. For example, as part of the setup process for the remote controller, the user may have supplied information indicating the priority of each device within a device type. In alternative embodiment, the remote controller may identify the highest ranking peripheral device within the applicable device type subset according to a predetermined algorithm, or another suitable system or process.

At step 630, the availability of the highest priority device within the device type subset may be determined. Determining the availability of the highest priority device within the subset may be accomplished using any of the aforementioned systems or processes. In one embodiment, the remote controller may access a record similar to record 400 or 450 depicted in FIG. 4 to determine whether the device is available. As described above, record 400 or 450 may be maintained at the remote controller, at another remote controller in system 100, at a switch within system 100, or at an independent database within system 100. In alternative embodiment, the remote controller may determine the availability of the highest ranking device within the applicable device type subset according to another suitable system or process.

Where it is determined that the highest priority device of the device type subset is available, the remote controller may then determine whether another device type is necessary to initiate the user-requested activity at step 640. For example, an activity associated with watching a DVD may require a DVD player device type and an A/V receiver device type. Thus, after an available DVD player has been identified, steps 620 and 630 may be repeated to identify an available A/V receiver or, vice versa, after an available A/V receiver has been identified, steps 620 and 630 may be repeated to identify an available DVD player.

At step 650, if no other device type is necessary to initiate the requested activity or an available device has been identified for each desired device type for the requested activity, the remote controller may transmit commands/signals to each identified device to configure the device(s) for initiation of the user-requested activity. As described above, and depending upon the communication capabilities and configuration of the remote controller and the identified device(s), the remote controller may transmit commands/signals directly to the identified device(s) via any suitable communication channel (e.g., IR, RF, or wi-fi signals). In another embodiment, the remote controller may transmit one or more commands/signals to repeater 180 via a suitable communication channel, and repeater 180 may then relay the commands/signals to the identified device(s), again via any suitable communication channel. Similarly, the remote controller may transmit one or more commands/signals, directly or via a repeater, to a switch in order to properly configure the switch to route signals output from the identified device(s) to the appropriate output or display device. Alternatively, switch 150 may self-configure in response to the configuration of one or more input and/or output devices without direct communication with the remote controller.

Once the user-requested activity has been initiated, or one or more commands/signals have been transmitted by the remote controller to initiate the requested activity, the remote controller may update one or more records to reflect the current status of any engaged input and output devices at step 660. As described above, any such record(s) may be stored in one or more databases integrated with the remote controller or maintained separately from the remote controller. For example, where the database is not integrated with the remote controller, it may be integrated with another remote controller in system 100 or integrated with a switch of system 100. Alternatively, it may be integrated with another processor- or controller-based device or may be a stand-alone, dedicated storage device. In still further embodiments, the record may be duplicated across a plurality of such databases in order to achieve faster data recall, redundancy, and data back-up functionality. In such an embodiment, the remote controller may update a record contained in a database integrated with the remote controller and transmit information indicative of the status of any newly engaged input and output devices to other remote controllers and/or switches within the system. In this manner, a plurality of devices in the system may maintain an up-to-date record comprising information pertaining to the status of one or more input and output devices.

Returning to step 630, where it is determined that the highest priority device of a device type subset is not available, it may be determined whether system 100 comprises one or more other devices of the desired device type at step 632. Determining whether system 100 comprises additional devices of the desired device type may be accomplished using any of the aforementioned systems or processes. In one embodiment, the remote controller may access a record substantially similar to record 400 or 450 depicted in FIG. 4 to determine whether the system comprises additional devices. For example, where the desired device type is a DVR and the highest priority DVR (e.g., DVR 1) is unavailable, the remote controller may access a record such as record 400 or 450 and determine that the system comprises additional DVRs (e.g., DVR 2 and DVR 3). As described above, record 400 or 450 may be maintained at the remote controller, at another remote controller in system 100, at a switch within system 100, or at an independent database within system 100. In an alternative embodiment, the remote controller may determine whether the system comprises another device of the device type subset according to another suitable system or process.

Where one or more additional devices of the desired device type subset are identified, step 620 may be repeated to identify the highest priority device of the one or more potential available devices remaining in the device type subset. Continuing with the example from the preceding paragraph, where it is determined that the system comprises additional, potentially available DVR 2 and DVR 3, the remote controller may identify which of the potentially available devices has the highest priority ranking. This identification may be accomplished using any of the aforementioned systems or processes. As discussed previously herein, the remote controller may access a record substantially similar to record 400 or 450 depicted in FIG. 4 to determine the highest ranking device within the identified, potentially available devices in the device type subset. In this example, the remote controller may access a record substantially similar to record 400 or 450 and, based at least in part on information contained therein, determine that DVR 2 is the highest priority device within the device type subset that may be available. Of course, in other embodiments, the remote controller may identify the highest ranking remaining device within the applicable device type subset according to another suitable system or process.

Following identification of the highest priority device within the applicable device type subset that may be available, step 630 may be repeated to determine the availability of the identified device.

This iterative loop comprising steps 620, 630, and 632 may be repeated until an available device of the applicable device type subset is identified. Alternatively, it may be determined at step 632 that every device of the applicable device type subset in the system is unavailable or the system contains no remaining, potentially available devices of the applicable device type subset. In such an instance, at step 634, the remote controller may display to the user, or cause to be displayed to the user, a message indicating that the requested activity is unavailable at this time. In one embodiment, the message may further indicate which other remote controllers in the system have engaged the device(s) of the applicable device type subset. In another embodiment, the message may not only indicate which other remote controllers in the system have engaged the device(s) of the applicable device type subset, but further associate a particular device with each other remote controller and/or indicate the time at which any ongoing activities were initiated. In still a further embodiment, the user may be able to terminate any ongoing activity that may have been initiated at another remote controller in the household.

For example, where no device of an appropriate device type is available and a list of one or more other remote controllers and/or the engaged peripheral devices may be displayed to the user, the user may selectively terminate an ongoing activity associated with one or more other remote controllers and/or engaged peripheral devices. In response to a request at the remote controller by the user to terminate an ongoing activity initiated by another remote controller, the remote controller may transmit commands/signals to the one or more peripheral devices and/or switches to effectively end the ongoing activity and initiate the activity originally requested by the user at the remote controller. In such an embodiment, the remote controller may also transmit information to the other remote controller at which the conflicting activity is/was taking place. In response to receiving this information from the remote controller, the other remote controller may display, or cause to be displayed, a termination or override message to a second user that may have been engaged in the conflicting activity, alerting the second user that the first user and/or remote controller has or will be initiating an activity that conflicts with the second user's ongoing activity. Reception of the information from the remote controller may further cause the other remote controller to transmit one or more commands/signals to one or more input and output devices. For example, reception of an override message from the remote controller at the other remote controller may cause the other remote controller to transmit a command/signal to a display device associated with the other remote controller to power down the display device that will no longer be in use.

In yet other embodiments, the process of overriding a pre-existing activity initiated at another remote controller may be automated and, in some embodiments, based at least in part on a priority ranking assigned to one or more remote controllers within the system, as described in further detail below.

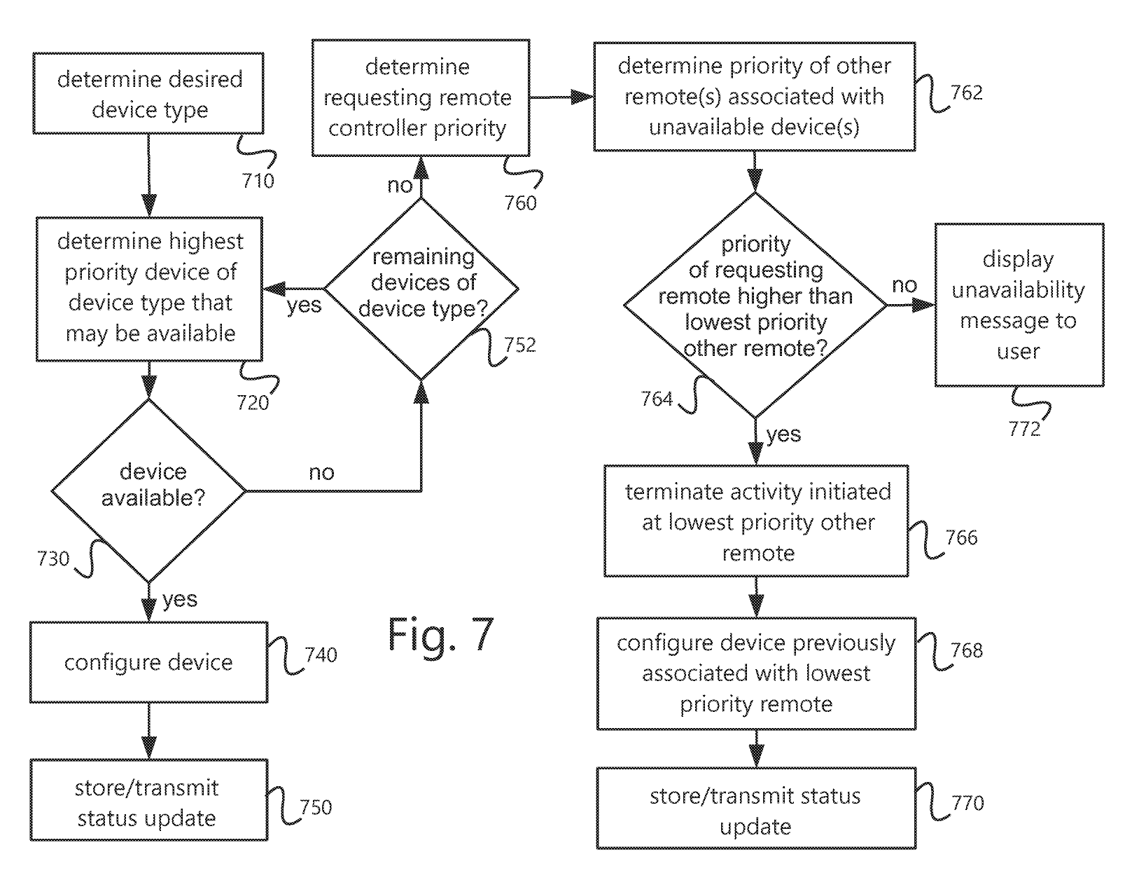

FIG. 7 depicts another illustrative method for configuring one or more peripheral devices and output devices by a remote controller in system 100. As depicted in FIG. 7, the remote controller may already be in possession or have access to status information pertaining to one or more devices in system 100. The status information may have been acquired or accessed according to any of the aforementioned systems or processes.

In one embodiment, steps 710, 720, 730, 740, and 750 may be substantially similar to corresponding steps 610, 620, 630, 650, and 660 depicted in FIG. 6. A step corresponding to step 640, i.e., determining whether another device type may be required to initiate the user-requested activity, is not shown in FIG. 7. Nonetheless, it should be appreciated that such a step may be incorporated into the process depicted in FIG. 7.

Moreover, step 752 of FIG. 7 may be substantially similar to step 632 of FIG. 6. However, rather than displaying, or causing to be displayed, a message indicating that the requested activity is unavailable where it is determined that every device of the applicable device type subset in the system is unavailable or the system contains no remaining, potentially available devices of the applicable device type subset (as described in step 634 of FIG. 6), at step 760, the remote controller may determine a priority ranking assigned to the remote controller. A determination of the remote controller's priority ranking may be accomplished using any of the aforementioned systems or processes. In one embodiment, the remote controller may access a record similar to record 400 or 450 depicted in FIG. 4 to determine the priority ranking assigned to the remote controller. As described above, record 400 or 450 may be maintained at the remote controller, at another remote controller in system 100, at a switch within system 100, or at an independent database within system 100. In other embodiments, the remote controller may access another similarly stored record comprising remote controller priority information, such as a record created based, at least in part, on feedback supplied by a user at the time system 100 and/or the remote controller were setup or initially configured. For example, as part of the setup process for the remote controller, the user may have supplied information indicating the priority of one or more remote controllers within the system. In alternative embodiment, the remote controller may identify its priority ranking according to a predetermined algorithm, or another suitable system or process.

At step 762, the remote controller may similarly determine the priority ranking associated with each other remote controller associated with previously-identified unavailable devices of the desired device type(s) necessary to initiate the user-requested activity. Such a determination of the priority ranking associated with each other remote controller may be carried out substantially similar to the determination of the priority ranking associated with the remote controller described above at step 760.

It may then be determined, at step 764, whether the priority of the remote controller at which the user has requested initiation of an activity (i.e., the requesting controller) is higher than the lowest priority ranking assigned to an identified other remote controller in system 100. For example, where the requesting controller is associated with a priority ranking of 2, and first and second other remote controllers associated with conflicting, ongoing activities (i.e., first and second other remote controllers associated with an ongoing activity involving input/output devices of one or more device type subsets necessary to initiate the activity requested at the requesting controller) have a priority ranking of 1 and 3, respectively, it may be determined that the requesting controller is associated with a lower priority ranking than the first other remote controller and a higher priority ranking than the second other remote controller.

In the event that the requesting controller is associated with a higher priority ranking than the lowest priority other remote controller (associated with previously-identified unavailable devices of the desired device type(s) necessary to initiate the user-requested activity), then the activity initiated by the lower priority other remote controller may be terminated, rendering the previously-identified unavailable devices associated with the other remote controller available for use in the user-requested activity. In one embodiment, the termination of the conflicting activity previously initiated at the other remote controller may be automatedly terminated. For instance, the requesting controller may directly terminate the conflicting activity by transmitting commands/signals to the appropriate input and output devices. Alternatively, the requesting controller may transmit a termination message to the other remote controller and the other remote controller may transmit command/signals to the appropriate input and output devices to terminate the ongoing activity.

In other embodiments, the requesting controller may display, or cause to be displayed, to the user requesting initiation of the activity a message indicating that the ongoing, conflicting activity may be terminated and further input from the user may be required prior to the termination of the conflicting activity.

In further embodiments, where a plurality of lower ranking other remote controllers may be associated with ongoing, conflicting activities, the user at the requesting controller may be presented with a list comprising all or a subset of the lower ranking remote controllers and, rather than terminating the conflicting activity associated with the lowest ranking other remote controller, the user at the requesting controller may select to terminate a conflicting activity associated with another remote controller having a higher priority ranking than the lowest ranked other remote controller but lower than the remote controller.

Upon termination of the conflicting activity, and availability of the previously unavailable input/output device(s), the requesting controller may configure the now-available devices for the user-requested activity and store any new device status information at steps 768 and 770, respectively. In one embodiment, steps 768 and 770 may be performed substantially similar to corresponding steps 650 and 660 of FIG. 6, and/or corresponding steps 740, 750 of FIG. 7.

Returning to step 764, where it is determined that the priority ranking of the requesting controller is not higher than the lowest ranking other remote controller associated with a conflicting, ongoing activity, a message may be displayed to the user indicating that the requested activity is unavailable at step 772. Display of such a message and/or the message content may be substantially similar to the message displayed at step 634 of FIG. 6.

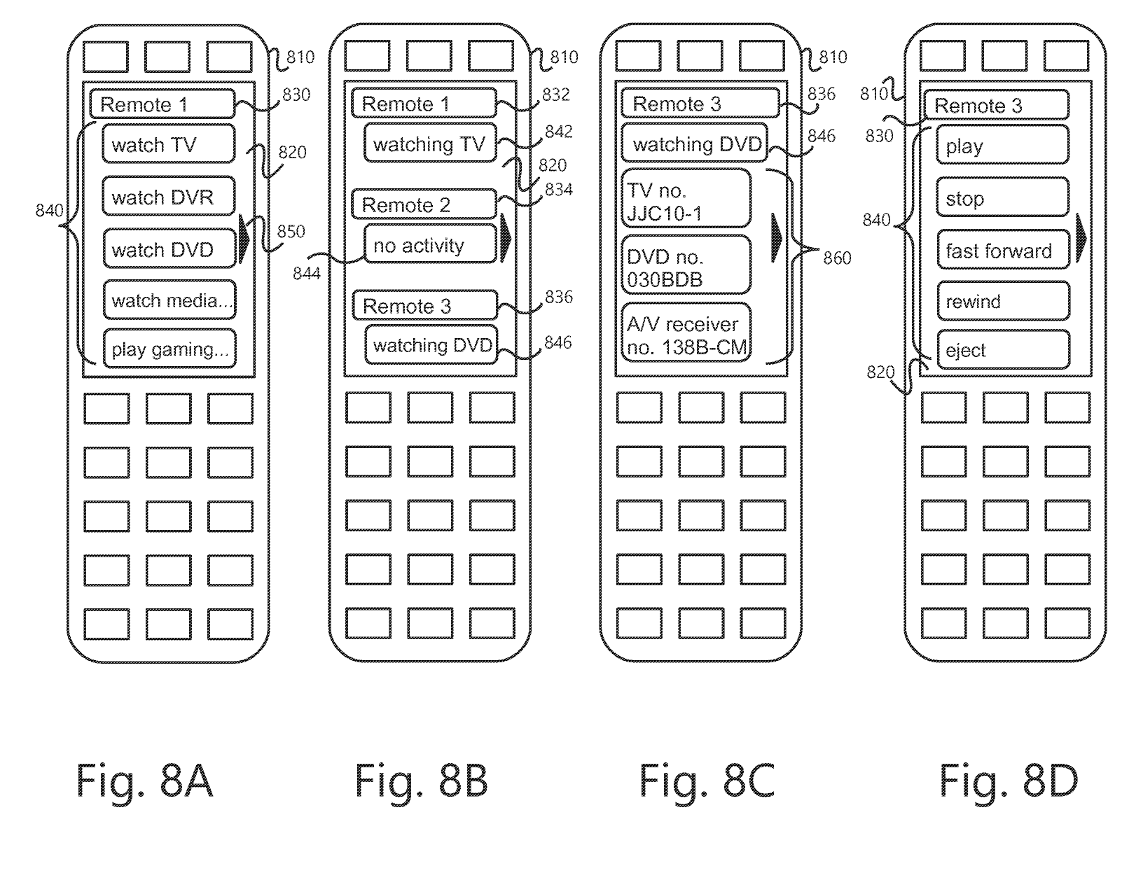

FIGS. 8A-D depict embodiments of a remote controller configured for use in system 100. In particular, user interfaces for one or more remote controllers in system 100 are depicted. In one aspect, shown in FIG. 8A, a remote controller 810 may comprise a display 820. Display 820, in some embodiments, may be a digital display for conveying information to a user. Display 820 may also be a touchscreen configured to accept inputs from the user by pressing on display 820 at a location corresponding to a “soft” or digitally-displayed button. Of course, in other embodiments, remote 810 may comprise other means of displaying information and/or options to the user, and/or alternative means of accepting one or more inputs from the user.

In another aspect, display 820 comprises a remote controller identifier 830. Remote controller identifier 830 may comprise any alphanumeric character string to differentiate the remote controller from one or more other remote controllers in system 100. For example, identifier 830 may comprise information indicative of remote controller 810's priority ranking, e.g., “remote controller 1” may indicate the remote controller in system 100 assigned the highest priority ranking. In other embodiments, identifier 830 may comprise information indicative of a media-consuming area of the household associated with remote controller 810, e.g. “family room” or “remote for den,” etc. Of course, other suitable alphanumeric strings for identifier 830 exist and the examples presented herein should not be construed as exhaustive of the possibilities.

In a further aspect, display 820 may comprise one or more activities that may be initiated at remote controller 810. In the example shown in FIG. 8A, one or more activities 840 that may be initiated at remote controller 810 comprise “watch TV,” “watch DVR,” “watch DVD,” “watch media streamer,” and “play gaming system.” Again, the activities presented in FIG. 8A are only illustrative and should not be considered an exhaustive list of the possibilities. Moreover, display 820 may comprise a soft button 850 for scrolling to view additional activities 840 that may not be in view on display 820. In other embodiments, rather than a soft button, remote controller 810 may comprise a physical or virtual scroll wheel, buttons, or some other input component for allowing a user to view information not presently in view on display 820.

From display 820, a user may request initiation of an activity by selecting any one of activities 840. Again, this selection may be performed using any combination of one or more soft and hard input buttons/components. The initiation of the requested activity may then proceed according to any of the aforementioned systems or methods.

FIG. 8B depicts another embodiment of a user interface that may be displayed at display 820 of remote controller 810. In one aspect, rather than depicting a remote controller identifier 830 and one or more activities that may be initiated at the remote controller, display 820 may depict a plurality of remote controller identifiers 832, 834, 836. It should be noted, although three identifiers 832, 834, 836 are depicted in FIG. 8B, additional, fewer, or alternative identifiers may be displayed in other embodiments, and the interface shown in FIG. 8B is only illustrative of the possibilities.

In another aspect, activities 842, 844, 846 may each be associated with a respective identifier 832, 834, 836 and comprise an indication of any ongoing activity initiated at the corresponding remote controller. For example, as shown in FIG. 8B, a television watching activity may have been initiated at remote controller 1, no ongoing activity may have been initiated at remote controller 2, and a DVD watching activity may have been initiated at remote controller 3. A determination as to which activities are ongoing and from which remote controller they were initiated can be accomplished according to any of the systems or methods described herein, and may or may not be based, at least in part, on one or more records similar to records 400 and 450 depicted in FIG. 4.

A relationship or association between each activity 842, 844, 846 and its corresponding remote controller identifier 832, 834, 836 within the interface may be conveyed to a user in any suitable manner. For example, activity 842 may be displayed at a position in display 820 with respect to its corresponding identifier 832 in such a way as to convey the relationship between activity 842 and identifier 832 (e.g., just below or adjacent to one another). Alternatively, or additionally, each identifier and associated activity may be displayed in a common color or font to convey the relationship between the two. Of course, these examples are only illustrative and should not be construed as exhaustive of the possibilities.

In a further aspect, identifier 832 associated with remote controller 810 may be presented differently from identifiers 834, 836 associated with other remote controllers in system 100 such that the user may be able to determine which remote controller in the system the user is currently viewing or manipulating. For example, where remote controller 810 is associated with “Remote 1,” identifier 832 may appear atop or in a different color/font as compared to the “Remote 2” identifier 834 and/or the “Remote 3” identifier 836.

In another aspect, from the interface depicted in FIG. 8B, a user may view additional information regarding any ongoing activity initiated at a remote controller within the system. For example, from the interface depicted in FIG. 8B, a user may select the “watching DVD” button, i.e., activity 846, associated with “Remote 3” to display the interface depicted at FIG. 8C. In one embodiment, the interface of FIG. 8C may comprise identifier 836 associated with “Remote 3” and activity 846 (e.g., “watching DVD”) within display 820.

Additionally, display 120 may comprise one or more device identifiers 860. In one embodiment, device identifiers 860 may each correspond to an input, output, or peripheral device engaged in activity 846. In this manner, a user may view a list of one or more devices engaged in an activity initiated at another remote controller within system 100. A determination as to which devices are engaged in activity 846 can be accomplished according to any of the systems or methods described herein, and may or may not be based, at least in part, on one or more records similar to records 400 and 450 depicted in FIG. 4.

In a further embodiment, the user may be able to select one or more of the device identifiers 860 in order to configure remote controller for transmitting commands/signals to the device associated with the selected identifier. There may be several advantages to an interface with the aforementioned capabilities. For example, where a child has initiated an activity in one media-consuming area of the household using a first remote controller and a parent desires to reduce the volume of the audio associated with that activity, the parent may use a second remote controller of system 100 to configure the second remote for communication with the audio-producing device associated with the child-initiated activity and transmit one or more commands/signals to turn the volume down without necessarily entering the same media-consuming area. Of course, this particular example is only illustrative of the possibilities. A user may utilize the systems, methods, and interfaces described herein in additional or alternative contexts.

In another aspect, from the interface depicted in FIG. 8B, a user may configure remote controller 810 to mirror or mimic another remote controller in system 100. In one embodiment, from the interface depicted in FIG. 8B, a user may select the “watching DVD” button, i.e., activity 846, associated with “Remote 3” to display the interface depicted at FIG. 8D. In one embodiment, the interface of FIG. 8D may reflect or mirror an interface displayed at Remote 3 that may be engaged in watching a DVD. Moreover, remote controller 810 may identify the same input/output device(s) that Remote 3 may be in communication with in conjunction with the ongoing activity, and/or determine the present configuration of such input/output device(s). In particular, remote controller may identify the appropriate input/output devices and their respective configurations according to any of the systems or methods described previously herein. For instance, such identification and configuration determination may or may not be based, at least in part, on one or more records similar to records 400 and 450 depicted in FIG. 4. In this manner, and for example, a user may achieve the same “parental controls” described above with respect to FIG. 8C. Alternatively, where multiple users are engaged in an activity within a media-consuming area of the household, a plurality of users may manipulate the devices engaged in the activity, each from a respective remote controller. Further, after each command/signal is transmitted from one remote controller, that remote controller may transmit update information to each mirrored remote controller in accordance with aforementioned systems and methods such that a plurality of remote controllers may remain apprised of the current device configuration within an ongoing activity.

Thus, in one embodiment, where two users are engaged in an ongoing activity at the same media-consuming area of the household and one is in possession of a remote controller that mirrors the other, both users may have the ability to transmit commands/signals to the appropriate devices engaged in the activity. This may be particularly helpful where one user falls asleep during the activity or leaves the room.

Such a mirroring of a remote controller may also be helpful when one or more remote controllers are each associated with a dedicated display device. In one embodiment, where Remote 1 is associated with a first display device in a first media-consuming area of the household and Remote 2 is associated with a second display device in a second media-consuming area of the household, a user may desire to mimic Remote 1 at Remote 2 in some situations. For example, when the user cannot locate Remote 1 or Remote 1's battery has died, the user may mimic Remote 1 at Remote 2 in order to initiate, terminate, or otherwise configure an activity at the first media-consuming area and/or associated with the first display device. In this manner, each remote controller of system 100 may be interchangeable with one another. Of course, the aforementioned examples are only illustrative of the possibilities. The systems, methods, and interfaces described herein may be used in a variety of suitable contexts.

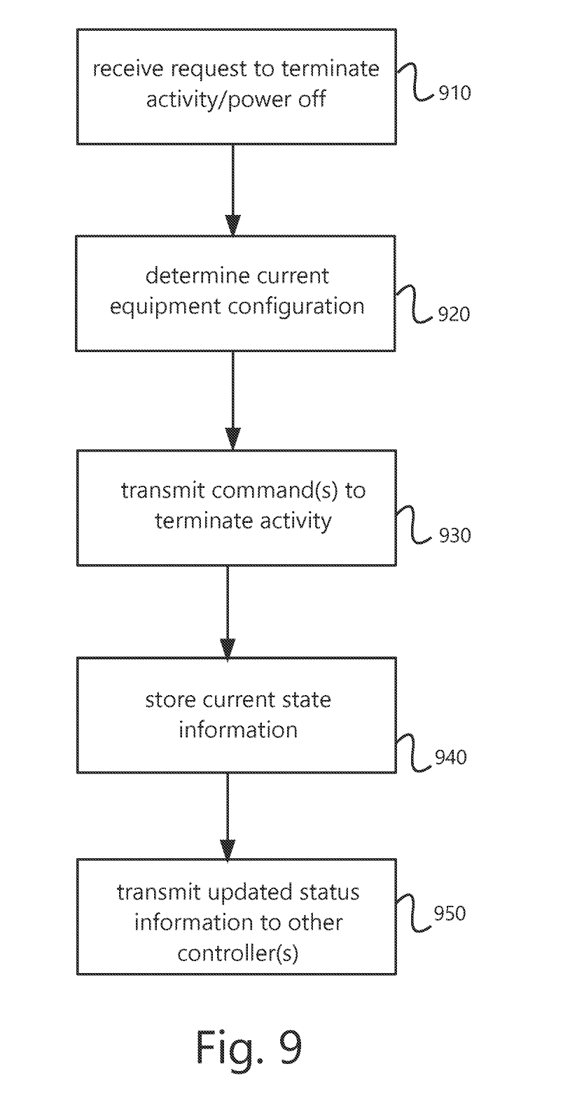

FIG. 9 depicts a process for receiving a request from a user at a remote controller to terminate an ongoing activity. At step 910, the remote controller may receive a request from the user to terminate one or more ongoing activities.

In response to receiving the user request, the remote controller may determine one or more peripheral devices currently engaged in the one or more activities to be terminated at step 920. The determination regarding which input and output devices may be engaged in the one or more activities to be terminated may be accomplished using any of the aforementioned systems or processes, and may or may not be based, at least in part, on one or more records similar to records 400 and 450 depicted in FIG. 4.

At step 930, the remote controller may communicate the appropriate commands/signals to the identified input and output devices to terminate the activity and, at step 940, the remote controller may update a record to reflect termination of the activity and/or the availability of the previously-engaged devices. Status update information may also be communicated to other remote controllers and/or switches within the system at step 950. In one embodiment, steps 930, 940, and 950 may be accomplished substantially similar to corresponding steps 360, 370, and 380, described in conjunction with FIG. 3 and with respect to initiating an activity or further configuring previously-engaged devices.

FIG. 10 depicts another embodiment of a system 1000 as described herein. In one aspect, the system may comprise a display device 1020 associated with an identification unit 1030. In one embodiment, identification unit 1030 can be an RFID tag storing data associated with a location and/or device, and may be further configured to receive and transmit information. In other embodiments, identification unit 1030 can be any processor- or controller-based, portable or non-portable, device for storing, receiving, and transmitting location information and/or information associated with a device. Further, while identification unit 1030 and display device 1020 are depicted as distinct objects, in other embodiments they may be incorporated into a single object or device such as a television or monitor. It should be noted that while FIG. 10 depicts one display device 1020 associated with one identification unit 1030, other embodiments may comprise additional display devices and/or identification units. For example, a household may comprise a first display device associated with a first identification unit in a first media-consuming area of the household (e.g., the living room), a second display device associated with a second identification unit in a second media-consuming area of the household (e.g., the master bedroom), and so on.

In another aspect, identification unit 1030 may store information identifying an associated output device, such as display device 1020. Alternatively, an identification unit 1030 may store information indicative of the identification unit's position within a household (e.g., living room, den, first bedroom, etc.). In such an embodiment, identification unit 1030 may store a table that associates its position within a household with an output device, such as a display device.

System 1000 may further comprise one or more remote controllers 1010a, 1010b. Though FIG. 10 depicts two remote controllers, other embodiments of system 1000 may comprise fewer or more controllers. Remote controllers 1010a, 1010b may be substantially similar to the remote controllers described previously herein. Remote controllers 1010a, 1010b, however, may further comprise respective identification unit readers 1012a, 1012b. In one aspect, identification unit readers 1012a, 1012b, like identification unit 1030, can be configured to store, receive, and transmit information. In one embodiment, one or more of identification unit readers 1012a, 1012b may be an RFID reader configured to store, interrogate, receive, and/or transmit information to and from an RFID tag such as identification unit 1030 via an RF communication channel. In other embodiments, identification unit reader 1012a, 1012b can be any processor- or controller-based component for storing, interrogating, receiving, and transmitting information from identification unit 1030. Moreover, one or more identification unit readers may be in communication with identification unit 1030 via a near-field, Bluetooth, Internet, network, or wi-fi communication channel. In further embodiments, the devices may be in one-way or two-way communication via another suitable communication channel.

As described in FIG. 10, one or more remote controllers may comprise an identification unit reader and one or more output devices may be associated with an identification unit. In alternative embodiments, however, the one or more remote controllers may comprise the identification unit and the one or more output devices may be associated with the identification unit readers.

In use, an identification unit reader that comes into proximity with identification unit 1030, and corresponding display 1020, may detect the presence of the identification unit. In one embodiment, an identification unit reader such as identification unit reader 1012a may transmit periodic interrogation signals at predetermined time intervals. When the identification unit reader comes into proximity with an identification unit and transmits an interrogation signal, the identification unit may receive the interrogation signal and respond by transmitting stored information to the interrogating identification unit reader. The stored information may comprise, among other things, information identifying an associated output or display device and/or position information.

The transmitted information may then be received by the identification unit reader and analyzed to determine the identity of an output or display device associated with the identification unit. In this manner, a remote controller in system 1000 does not need to be dedicated to a particular output/display device and/or media-consuming area of the household. Rather, when a user requests initiation of an activity at a remote controller as described previously herein, the output or display device(s) to be configured in conjunction with the requested activity may be determined based on the location of the remote controller or the output/display device physically located nearest the remote controller. Thus, every remote controller comprising an identification unit reader in a household may be used in any of a plurality of media-consuming areas of the household (and associated output/display devices).

As shown in FIG. 10, a pair of users 1040a, 1040b, both located within the same media-consuming area of the household, may transmit commands/signals in conjunction with an ongoing activity from their respective remote controllers 1010a, 1010b. As described previously, after each command/signal is transmitted by one of remote controllers 1010a, 1010b, status update information may be transmitted to the other remote controller such that both remote controllers may have access to up-to-date information regarding any engaged device's present configuration.

In another aspect, one of the users may leave the depicted media-consuming area with a respective remote controller and enter another media-consuming area comprising a second identification unit associated with a second output/display device. Through the aforementioned interrogation process, that remote controller may then obtain information identifying the second output/display device and associate any newly requested activities with that second output/display device.

FIG. 11 depicts a more detailed embodiment of an identification unit 1110 substantially similar to identification unit 1030 described in FIG. 10, and an identification unit reader 1150 substantially similar to identification unit 1012a, 1012b, wherein identification unit 1110 may be an RFID tag and identification unit reader 1150 may be an RFID reader.

In one aspect, identification unit reader 1150 may comprise a processor 1155, a memory 1160, an interface 1165, and a transceiver 1175. Processor 1155 may be substantially similar to the processor described above with respect to FIG. 2, and can be configured to receive and process data signals recovered from identification unit 1110 via an antenna 1170. Processor 1155 can be further configured to communicate any signals received from identification unit 1110 with other systems and/or components, such as one or more remote controllers, switches/matrices, independent databases, etc. via antenna 1170 or interface 1165. Alternatively, processor 1155 can be configured to communicate received signals to systems and/or components outside of system 1000.

Memory 1160 may include one or both of a random access memory (RAM) and a read-only memory (ROM) which can provide storage for program instructions, parameters, and data for processor 1155. In one embodiment, memory 1160 can contain instructions that can be executed by processor 1155 to cause the processor to receive, write, and/or manipulate data transmitted by identification unit 1110. Memory 1160 may further comprise a flash memory or electronically erasable programmable read-only memory (EEPROM).

In another aspect, identification unit reader 1150 may further comprise additional peripheral systems at interface 1165 such as a display, keyboard, printer, fixed memory storage device, and/or other peripherals in communication with processor 330.

Transceiver 1175 can be configured to facilitate one-way or two-way RF communication between identification unit reader 1150 and identification unit 1110 under the control of processor 1155. In one aspect, transceiver 1175 may comprise a transmitter 1180, a receiver 1185, and a hybrid 1190. Hybrid 1190 can be coupled to antenna 1170. Hybrid 1190 can also connect transmitter 1180 and receiver 1185 to antenna 1170 while isolating them from each other. In this manner, hybrid 1190 can allow antenna 1170 to transmit a strong signal from transmitter 1180 and receive a weak back-scattered signal reflected from identification unit 1110. In some embodiments, hybrid 1190 may further comprise a circulator, directional coupler, or some similar component facilitating bi-directional communication of signals between identification unit reader 1150 and identification unit 1110 with sufficient signal isolation.

In another aspect, transmitter 1180 may comprise a local oscillator configured to generate an RF carrier frequency. In use, transmitter 1180 can send a transmission signal modulated by the RF carrier frequency to hybrid 1190, which can then pass the signal to antenna 1170. Antenna 1170 may then broadcast the modulated signal and capture any signal radiated by identification unit 1110. For example, antenna 1170 may broadcast a “wake-up” signal to identification unit 1110, which then responds by broadcasting data stored in identification unit 1110 back to identification unit reader 1150.

In a further aspect, antenna 1170 can pass any signals captured from identification unit 1110 back to hybrid 1190, which can forward the signal to receiver 1185 and processor 1155.

Of course, the aforementioned embodiments of identification unit reader 1150 are illustrative only. It should be appreciated that any known embodiment for a suitable RFID reader can be utilized within the present disclosure. Alternatively, identification unit reader 1150 can comprise another type of reader that does not rely on RF transmission, as discussed above with respect to other embodiments.

As further depicted in FIG. 11, identification unit 1110 can be an RFID tag comprising a memory 1115, a control logic 1120, a communication interface 1130, and an antenna 1140. Communication interface 1130 can be coupled to antenna 1140, and may include a transceiver for transmitting and receiving RF signals. The transceiver may further comprise a modulator adapted to backscatter modulate the impedance match with the antenna in order to transmit data signals by reflecting a continuous wave (CW) signal provided by identification unit reader 1150.

Control logic 1120 can control the functions of identification unit 1110 in response to commands provided by identification unit reader 1150 that may be embedded in a received RF signal. Control logic 1120 can also be configured to access memory 1115 to read and/or write data therefrom. Control logic 1120 can also convert analog data signals recovered by interface 1130 into digital signals comprising the received commands, and can convert digital data retrieved from memory 1115 into analog signals that are backscatter modulated by interface 1130.

In a further aspect, identification unit 1110 may be adapted to derive electrical power from an interrogating signal transmitted by identification unit reader 1150. Alternatively, identification unit 1110 may comprise its own power source.

Like identification unit reader 1150, the aforementioned embodiments of identification unit 1110 are illustrative only. It should be appreciated that any known embodiment for a suitable RFID tag can be utilized within the present disclosure. Alternatively, identification unit 1110 can comprise another type of device that does not rely on RF transmission, as discussed above with respect to other embodiments.

In one aspect, identification unit reader 1150 may be configured to read data stored in identification unit 1110 automatically as identification unit reader 1150 comes into proximity with identification unit 1110. In one embodiment, such reading can be performed without any physical intervention by a user. In other words, in embodiments where identification unit reader 1150 is integrated into a remote controller and accompanies the user into a media-consuming area of a household, identification unit reader 1150 and identification unit 1110 can engage in one- or two-way communication any time the remote controller enters the media-consuming area, without any action being required by the user. In some embodiments, identification unit reader 1150 may be configured such that it is in a constant “ready” state in which it periodically transmits an interrogation signal to determine if one or more identification units 1110 are in proximity. In alternative embodiments, identification unit reader 1150 can be selectively enable and/or disabled, for example in order to preserve battery power during periods of non-use. In still further embodiments, identification unit reader 1150 may be coupled to a motion sensor through interface 1165 that triggers transmission of an interrogation signal by identification unit reader 1150 when movement of the remote controller is detected. Thus, identification unit reader 1150 can be kept in a disabled or “sleep” mode until the movement of the associated remote controller by a user is detected, at which time identification unit reader 1150 can switch to a ready state and transmit an interrogation signal to any nearby identification units 1110.

Additional features can also be incorporated into the described systems and methods to improve their functionality. For example, one or more remote controllers may be assigned to a particular user rather than, or in addition to, one or more output devices and/or media-consuming location in a household. In such embodiments, the remote controller(s) may store information indicative of a user's behavior, such as what activities that user typically requests and/or frequent device configurations. In this manner, the remote controller may display those activities and/or commands/signals that a user requests most frequently more prominently or in a different fashion than lesser requested activities and/or commands/signals. In other embodiments, one or more remote controllers may be integrated with another electronic device rather than being a dedicated, standalone device. For example, one or more remote controllers may be integrated with a cell phone, smart phone, tablet, laptop, etc. In a further embodiment, use of the remote controllers may extend outside a household (e.g., to a user's vehicle or workplace). Alternatively, or additionally, the remote controllers may be used across a plurality of households (i.e., inter-household). Of course, it should be obvious that the aforementioned systems and methods may also be used outside a residential context, for example, in commercial and industrial contexts.

Other embodiments will be apparent to those skilled in the art from consideration of the specification and practice of this disclosure. It is intended that the specification and examples be considered as illustrative only, with the true scope and spirit of the disclosure being indicated by the following claims.

What is claimed is:

1. A communication system for consuming media content, the system comprising:
one or more input devices for providing content associated with one or more media-consuming activities;
a switch configured to transmit the content from the one or more input devices to at least one output device; and
a plurality of controller devices for initiating any of the one or more media-consuming activities, each of the plurality of controller devices being communicatively coupled to the one or more input devices and the switch device;
wherein each controller device, upon receiving a request from a user to initiate a first media-consuming activity associated with a first input device, determines an availability of the first input device based, at least in part, on status information transmitted by another controller device.

2. The communication system of claim 1, wherein each of the plurality of controller devices receives a status update from another controller device, the status update comprising information indicative of a state of at least one of the one or more input devices.

3. The communication system of claim 1, wherein each of the controller devices receives a status update from the switch, the status update comprising information indicative of a state of at least one of the one or more input devices.

4. The communication system of claim 1, wherein each of the controller devices comprises a database, the database comprising status data indicative of a state of each of the one or more input devices.

5. The communication system of claim 4, wherein the database further comprises controller identification data associating the state of each of the one or more input devices engaged in an ongoing activity with a controller device identifier.

6. The communication system of claim 1, wherein the switch comprises a database, the database comprising status data indicative of a state of each of the one or more input devices.

7. The communication system of claim 6, wherein the database further comprises controller identification data associating the state of each of the one or more input devices engaged in an ongoing activity with a controller device identifier.

8. A controller apparatus for initiating a media-consuming activity, the apparatus comprising:
a memory;
a processor operatively coupled to the memory and configured to perform steps comprising:
receiving a request from a user to initiate a media consuming activity;
determining one or more desired device type subsets associated with the media consuming activity; and
for each desired device type subset associated with the media-consuming activity, determining an availability of a device of the device type subset based, at least in part, on status information indicative of media-consuming activities associated with one or more other controller apparatuses.

9. The controller apparatus of claim 8, wherein the status information comprises data indicative of a state of at least one device of the one or more desired device type subsets.

10. The controller apparatus of claim 8, wherein the determining the availability of the device of the device type subset comprises:
identifying a highest priority device of the device type subset that may be available; and
determining an availability of the highest priority device of the device type subset.

11. The controller apparatus of claim 10, further comprising:
determining that the highest priority device is unavailable;
determining there is another device of the device type subset that may be available;
identifying a next highest priority device of the device type subset that may be available; and
determining the availability of the identified next highest priority device of the device type subset based, at least in part, on the status information indicative of media-consuming activities associated with one or more other controller apparatuses.

12. The controller apparatus of claim 8, further comprising:
determining that the device of the device type subset is unavailable;
determining a priority associated with the controller apparatus;
identifying an other controller apparatus associated with an ongoing activity associated with the identified device;
determining a priority associated with the other controller apparatus;
determining that the priority of the controller apparatus is greater than the priority of the other controller apparatus; and
terminating the ongoing activity.

13. The controller apparatus of claim 12, wherein identifying the other controller apparatus is based, at least in part, on the status information.

14. The controller apparatus of claim 12, wherein determining the priority of the other controller apparatus is based, at least in part, on the status information.

15. The controller apparatus of claim 12, wherein the ongoing activity involving the identified device was initiated at the other controller apparatus.

16. A non-transitory, computer-readable medium containing instructions that, when executed by a processor, perform a method comprising:
receiving a request by a user to initiate an activity;
identifying at least one content device associated with the activity;
determining an availability of the at least one content device based, at least in part, on status information received from one or more activity-initiating devices, the status information comprising data indicative of at least one ongoing activity;
transmitting a command to an available content device to initiate, at least in part, the activity; and
transmitting a status update to the one or more activity-initiating devices, the status update comprising data indicative of a state of the identified content device.

17. The non-transitory, computer-readable medium of claim 16, wherein the determining the availability of the at least one content device further comprises:
determining that the at least one content device is engaged in an ongoing activity initiated at a first activity-initiating device based, at least in part, on the status information;
determining a priority associated with the first activity-initiating device; and
terminating the ongoing activity based, at least in part, on the priority associated with the first activity-initiating device.

18. The non-transitory, computer-readable medium of claim 16, wherein determining an availability of the at least one content device comprises:
determining that a first content device associated with the activity is unavailable based, at least in part, on the status information; and
determining that a second content device associated with the activity is available based, at least in part, on the status information.

19. The non-transitory, computer-readable medium of claim 18, wherein the first content device is associated with a higher priority than the second content device.

20. The non-transitory, computer-readable medium of claim 16, wherein the status information further comprises data associating each of the at least one ongoing activities with a respective content device and a respective activity-initiating device at which the ongoing activity was initiated.
